(19) United States
(12) Patent Application Publication
(10) Pub. No.: US 2023/0068903 A1
(43) Pub. Date: Mar. 2, 2023

(54) MITIGATING DEFECTS USING POLYGON ABLATION PATTERN

(71) Applicant: View, Inc., Milpitas, CA (US)

(72) Inventors: Madhura R. Gadre, Mountain View, CA (US); Todd William Martin, Mountain View, CA (US)

(21) Appl. No.: 17/760,289

(22) PCT Filed: Feb. 5, 2021
(86) PCT No.: PCT/US2021/016937

§ 371 Date: Aug. 5, 2022

Related U.S. Application Data
(63) Continuation-in-part of application No. 16/748,638, filed on Jan. 21, 2020.
Application No. 16/748,638 is a continuation of application No. 14/398,117, filed on Oct. 30, 2014, now Pat. No. 10,583,523.
(60) Provisional application No. 62/970,581, filed on Feb. 5, 2020.
(60) Provisional application No. 61/649,184, filed on May 18, 2012.

(51) Int. Cl. B23K 26/046; B23K 26/06; B23K 26/08; B23K 26/40; B23K 26/361

(52) U.S. Cl. CPC B23K 26/046; B23K 26/06; B23K 26/08; B23K 26/40; B23K 26/361; G02F 2201/508; B23K 2103/50

(57) ABSTRACT

Methods of determining a polygon ablation pattern for use in mitigating one or more defects in an optical device are described. A method comprises identifying spatial coordinates of one or more defects areas in a first image of the optical device taken when tinted, defining a region of interest around at least one defect area of the one or more defect areas, and determining a polygon boundary around the at least one defect area in the region of interest to define the polygon ablation pattern.

### PRIORITY DATA

This application claims benefit of and priority to U.S. Provisional Application 62/970,581, filed on Feb. 5, 2020 and titled “MITIGATING DEFECTS USING POLYGON ABLATION PATTERN;” this application is a continuation-in-part of U.S. patent application Ser. No. 16/748,638, titled “CIRCUMSCRIBING DEFECTS IN OPTICAL DEVICES” and filed on Jan. 21, 2020, which is a continuation of U.S. patent application Ser. No. 14/398,117, filed on Oct. 30, 2014 and titled “CIRCUMSCRIBING DEFECTS IN OPTICAL DEVICES,” which is a national phase application under 35 U.S.C. § 371 of International PCT application PCT/US2013/041365 (designating the United States), filed on May 16, 2013 and titled “CIRCUMSCRIBING DEFECTS IN OPTICAL DEVICES,” which claims benefit of and priority to U.S. Provisional Patent Application Ser. No. 61/649,184, filed on May 18, 2012, titled “CIRCUMSCRIBING DEFECTS IN OPTICAL DEVICES;” each of these applications is hereby incorporated by reference in its entirety and for all purposes.

### FIELD

The description relates generally to optical devices, more particularly to methods and apparatus related to mitigation of defects in optical devices, for example, flat panel displays, electrochromic windows and the like.

### BACKGROUND

Optical devices include photovoltaics, electrochromic devices, thermochromic devices, flat panel displays and the like. Advancements in optical device technology have increased dramatically in recent years including ever lower levels of defectivity in the thin film device that generates the desired optical and/or electrical properties. This is particularly important in devices where visual perception of the device is important, because defects often manifest themselves as visually discernible, and thus unattractive, phenomenon to the end user. Still, even with improved manufacturing methods, optical devices have some level of defectivity. Moreover, even if an optical device is manufactured with no visible defects, such visible defects may manifest during testing and/or deployment of the optical device. One particularly troublesome defect is an electrical short circuiting defect in an optical device.

### SUMMARY

Various methods herein can be applied to virtually any optical device that includes a material that can be isolable locally or where the defect is stationary; e.g., all solid state electrochromic devices are well suited for methods described herein. Herein are described methods for circumscribing defects in optical devices, e.g., in switchable electrochromic windows. For convenience, methods are described in terms of application to electrochromic devices; however, this is only meant as a means to simplify the description. Methods described herein may be performed on an electrochromic device of an electrochromic lite prior to incorporation into an insulated glass unit (IGU), after incorporation into an IGU (or laminate), or both.

Certain aspects pertain to a method of forming a laser ablation perimeter surrounding a defect in an optical device, the method including: a) starting application of a laser at a first fluence level in a first region of the laser ablation perimeter; b) translating the laser from the first region to a second region of the laser ablation perimeter, while increasing the fluence level of the laser as it transitions from the first region to the second region; and c) returning the laser to the first region in order to close the perimeter while decreasing the fluence level of the laser; wherein the energy about the laser ablation perimeter is substantially uniform and the overlap of the laser in the first region is at least about 25%. Decreasing the fluence level may include defocusing the laser.

Certain aspects pertain to a method of forming a laser ablation perimeter surrounding a defect in an optical device, the method including forming the laser ablation perimeter by overlapping a starting and a stopping laser ablation position, wherein the overlap of the starting and the stopping positions is less than about 25%.

Certain aspects pertain to a method of forming a laser ablation perimeter surrounding a defect in an optical device, the method including: a) starting application of a laser at a first position within an area that will be surrounded by the laser ablation perimeter; b) translating the laser from the first position to a second position, the second position being a part of the laser ablation perimeter; c) translating the laser about the defect until the laser focus is proximate the second position; d) closing the laser ablation perimeter by overlapping the second position with the laser focus; and e) returning the laser to the area surrounded by the laser ablation perimeter. In one embodiment, e) includes returning the laser to the first position.

In embodiments where overlapping laser lines or points do not include overlap between start and stop positions of a laser, the overlap can be between about 10% and about 100% of the laser line or point, or between about 25% and about 90% of the laser line or point, or between about 50% and about 90% of the laser line or point.

Certain aspects pertain to a method of forming a laser ablation perimeter surrounding a defect in an optical device, the method including: a) starting application of a laser at a first position, within the line that will define the laser ablation perimeter; b) translating the laser about the defect until the laser focus is proximate the first position; c) closing the laser ablation perimeter by overlapping the laser focus with the first position; and d) moving the laser to the area surrounded by the laser ablation perimeter. In one embodiment, d) includes moving the laser to the center of the perimeter. In one embodiment, d) includes moving the laser inside the first position in a spiral pattern, at least some overlap occurring in the spiral pattern.

Certain aspects pertain to a method of forming a laser ablation perimeter surrounding a defect in an optical device, the method including: a) starting application of a laser at a first position, within the area that will be surrounded by the laser ablation perimeter; b) translating the laser from the first position to a second position, the second position being a part of the laser ablation perimeter; c) translating the laser about the defect until the laser focus is proximate the second position; and d) closing the laser ablation perimeter by overlapping the second position with the laser focus, wherein the closure position is also the stopping position of the laser.

Certain aspects pertain to a method of forming a substantially circular laser ablation perimeter surrounding a defect in an optical device, the method including: a) starting application of a laser at a first position, the first position located at what will be the center of the substantially circular laser ablation perimeter; b) translating the laser from the first position to a second position, the second position being a part of the laser ablation perimeter; c) translating the laser about the defect in a substantially circular pattern until the laser focus is proximate the second position; d) closing the laser ablation perimeter by overlapping the second position with the laser focus; and e) returning the laser to the first position where the laser ablation is ceased.

Certain aspects pertain to a method of forming a laser ablation perimeter surrounding a defect in an optical device, the method comprising: a) energizing a laser while the laser beam is shuttered; b) allowing the laser to reach a steady state energy level; and c) circumscribing the defect with the laser.

Certain aspects pertain to a method of forming a laser ablation perimeter surrounding a defect in an optical device, the method including: a) starting application of a laser at a starting position, within the area that will be surrounded by the laser ablation perimeter; b) translating the laser from the first position and about the defect until the laser focus crosses its own path, but not at the starting position. The laser may be stopped at the crossing point or once past the crossing point.

Certain aspects pertain to a method of forming a laser ablation perimeter surrounding a defect in an optical device, the method including: a) starting application of a laser at a first position, within the area that will be surrounded by the laser ablation perimeter; b) translating the laser from the first position to a second position, the second position being a part of the laser ablation perimeter; and c) translating the laser about the defect until the laser focus crosses its own path, between the first and second position. The laser may be stopped at the crossing point or once past the crossing point.

Certain aspects pertain to a method of forming a laser ablation perimeter about a defect in an optical device. The method includes starting application of a laser with a laser focus at a first position located proximate the defect and at least partially mitigating the defect. The method moves the laser focus from the first position to a second position at the laser ablation perimeter. The method also moves the laser focus along the laser ablation perimeter until the laser focus is proximate the second position and then closes the laser ablation perimeter. There may be an overlap at the second position.

Certain aspects pertain to a method of ablating a defect in an optical device. The method includes starting application of a laser with a laser focus at a first position at or near the defect and moving the laser focus to cover one or more regions around the defect. The laser focus can be moved to cover the regions by, for example, rasterizing the laser focus over the one or more regions. There may be overlap of the laser focus during rasterizing, or not. A regular or irregular area of laser ablation may result.

Certain aspects pertain to a method of determining a polygon ablation pattern for mitigating one or more defects in an optical device. The method includes (a) identifying spatial coordinates of one or more defect areas in a first image of the optical device taken when tinted, (b) defining a region of interest around at least one defect area of the one or more defect areas, and (c) determining a polygon boundary around the at least one defect area in the region of interest to define the polygon ablation pattern. In one aspect, the method also includes directing, or causing the direction of, one or more laser spots to (i) follow the polygon boundary and/or (ii) scan over a region within the polygon boundary.

Certain aspects pertain to a method of mitigating one or more defects in an optical device. The method includes: (a) identifying spatial coordinates of one or more defect areas in an image of the optical device taken when tinted, (b) determining a polygon boundary around the one or more defect areas, and (c) directing, or causing the direction of, one or more laser spots to follow along the polygon boundary to mitigate the one or more defects in the optical device. In one aspect, the one or more laser spots are configured to start and stop within the polygon boundary. In one aspect, the one or more laser spots follow a path that overlaps, e.g., by 10%. In one aspect, the depth of laser ablation is at least through one layer of the optical device.

These and other features and advantages will be described in further detail below, with reference to the associated drawings.

### BRIEF DESCRIPTION OF THE DRAWINGS

The following detailed description can be more fully understood when considered in conjunction with the drawings in which:

FIG. 1A is a schematic cross-section of an electrochromic device in a bleached state.

FIG. 1B is a schematic cross-section of an electrochromic device in a colored state.

FIG. 2 is a schematic cross-section of an electrochromic device having an ion conducting electronically insulating interfacial region rather than a distinct IC layer.

FIG. 3 is a schematic cross-section of an electrochromic device with a particle in the ion conductor layer causing a localized defect in the device.

FIG. 4A is a schematic cross-section of an electrochromic device with a particle on the conductive layer prior to depositing the remainder of the electrochromic stack.

FIG. 4B is a schematic cross-section of the electrochromic device of FIG. 4A, where a “pop off” defect is formed during electrochromic stack formation.

FIG. 4C is a schematic cross-section of the electrochromic device of FIG. 4B, showing an electrical short that is formed from the pop off defect once the second conductive is deposited.

FIG. 5 depicts an electrochromic lite having three halo shorting type defects while the lite is in the colored state, before and after laser scribe to convert the halos into pinholes.

FIGS. 6A-B depict a conventional laser ablation circumscription of a particle defect.

FIG. 7 depicts a conventional laser ablation circumscription pattern.

FIG. 8 depicts a laser ablation circumscription as described herein.

FIGS. 9-14 depict various laser ablation circumscription patterns in accord with embodiments described herein.

FIG. 15 shows images of actual laser ablations of varying sizes following a scribe pattern as described in relation to FIG. 7.

FIG. 16 shows a schematic drawing illustrating a method of ablating a defect that moves a laser focus in a pattern that covers an area encompassing the defect.

FIG. 17 depicts a flowchart illustrating operations of a method of determining a polygon ablation pattern employing imaging processing techniques, according to embodiments.

FIG. 18 depicts a flowchart illustrating an example of sub-operations of an operation in the flowchart shown in FIG. 17, according to certain aspects.

FIG. 19 depicts an arrangement of images of a tinted electrochromic device that schematically illustrates output from and the flow of image processing sub-operations of an operation from the flowchart shown in FIG. 18, according to one aspect.

FIG. 20 depicts a flowchart illustrating an example of image processing sub-operations of an operation from the flowchart shown in FIG. 18, according to one aspect.

FIG. 21 depicts an arrangement of images of a tinted electrochromic device that schematically illustrates output from and the flow of image processing sub-operations shown in FIG. 18 and shown in FIG. 20, according to one aspect.

FIG. 22 depicts an arrangement of images of a tinted electrochromic device that schematically illustrates output from and the flow of image processing sub-operations shown in FIG. 18 and shown in FIG. 20, according to one aspect.

FIG. 23 depicts an expanded image of a rectangular portion of the non-enhanced defect image of the lite shown in FIG. 22.

FIG. 24 depicts an arrangement of images of a tinted electrochromic device that schematically illustrates output from and the flow of image processing sub-operations shown in FIG. 18 and shown in FIG. 20, according to one aspect.

FIG. 25 depicts an expanded image of the rectangular portion of the non-enhanced defect image of the lite shown in FIG. 24.

FIG. 26 depicts a schematic illustration of a method of mitigating an elongated defect in an electrochromic lite that includes a technique for generating a polygon ablation pattern, according to one aspect.

FIG. 27 depicts a schematic illustration of a method of mitigating a defect in an electrochromic lite that includes a technique for generating a polygon ablation pattern, according to one aspect.

FIG. 28 depicts a schematic illustration of a method of mitigating a cluster of defects in an electrochromic lite that includes a technique for generating a polygon ablation pattern, according to one aspect.

FIG. 29 depicts a schematic diagram of a system for generating a polygon ablation pattern based on one or more defects in an optical device, according to certain embodiments.

### DETAILED DESCRIPTION

For the purposes of brevity, embodiments described below are described in terms of an electrochromic lite. One of ordinary skill in the art would appreciate that methods and apparatus described herein can be used for virtually any optical device having shorting type defects. Optical devices include electrochromic devices, thermochromic devices, flat panel displays, photovoltaic devices, and the like. Also, various embodiments are described in terms of forming a laser ablation perimeter about a defect. Typically, these perimeters are drawn or described as being circular. This is not necessary, and the perimeters can be of any shape, whether regular or irregular. Lasers are particularly useful in forming the perimeters, but other focused energy sources can be substituted for any embodiment described herein; this is particularly so when the focused energy source has associated transient energy flux associated with powering up or turning off the focused energy applied to perform the process. Other focused energy sources may include ion beams, electron beams, and electromagnetic beams having different frequencies/wavelengths, for example.

For context, a description of electrochromic devices and defectivity in electrochromic devices is presented below. For convenience, solid state and inorganic electrochromic devices are described, however, the embodiments are not limited in this way, i.e., the embodiments apply to any device where a defect, e.g., an electrical shorting defect, can be excised by circumscription with a laser or other suitable energy source.

### I. Electrochromic Devices

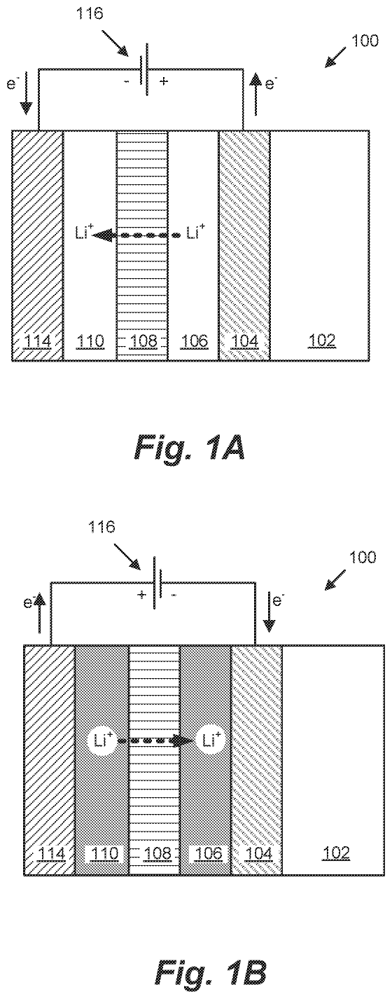

FIG. 1A depicts a schematic cross-section of an electrochromic device, 100. Electrochromic device 100 includes a transparent substrate, 102, a conductive layer, 104, an electrochromic layer (EC), 106, an ion conductor layer (IC), 108, a counter electrode layer (CE), 110, and a conductive layer (CL), 114. This stack of layers 104, 106, 108, 110, and 114 are collectively referred to as an electrochromic device or coating. This is a typical, though non-limiting, construct of an electrochromic device. A voltage source, 116, typically a low voltage source operable to apply an electric potential across the electrochromic stack, effects the transition of the electrochromic device from, for example, a bleached state to a colored state. In FIG. 1A, the bleached state is depicted, e.g., the EC and CE layers are not colored, but rather transparent. The order of layers can be reversed with respect to the substrate. Some electrochromic devices will also include a capping layer to protect conductive layer 114. This capping layer may be a polymer and/or an additional transparent substrate such as glass or plastic. In some devices, one of the conductor layers is a metal to impart reflective properties to the device. In many instances, both conductive layers 114 and 104 are transparent, e.g., transparent conductive oxides, like indium tin oxide, fluorinated tin oxide, zinc oxides and the like. Substrate 102 is typically a transparent, e.g., glass or plastic material.

Certain devices employ electrochromic and counter electrode (ion storage) layers that are complementarily coloring. For example, the ion storage layer 110 may be anodically coloring and the electrochromic layer cathodically coloring. For device 100 in the bleached state as depicted in FIG. 1A, when the applied voltage is applied in one direction as depicted, ions, for example lithium ions, are intercalated into ion storage layer 110, the ion storage layer is bleached. Likewise, when the lithium ions move out of electrochromic layer 104, it also bleaches, as depicted. The ion conductor layer allows movement of ions through it, but it is electrically insulating, thus preventing short circuiting the device between the conductor layers (and electrodes formed therefrom).

Electrochromic devices, e.g., those having distinct layers as described above, can be fabricated as all solid state and inorganic devices with low defectivity. Such all solid-state and inorganic electrochromic devices, and methods of fabricating them, are described in more detail in U.S. patent application Ser. No. 12/645,111, entitled, “Fabrication of Low-Defectivity Electrochromic Devices,” filed on Dec. 22, 2009 and naming Mark Kozlowski et al. as inventors, and in U.S. patent application Ser. No. 12/645,159 (now U.S. Pat. No. 8,432,603), entitled, “Electrochromic Devices,” filed on Dec. 22, 2009 and naming Zhongchun Wang et al. as inventors, both of which are incorporated by reference herein for all purposes.

It should be understood that the reference to a transition between a bleached state and colored state is non-limiting and suggests only one example, among many, of an electrochromic transition that may be implemented. Unless otherwise specified herein, whenever reference is made to a bleached-colored transition, the corresponding device or process encompasses other optical state transitions, such as non-reflective-reflective, transparent-opaque, etc. Further, the term “bleached” refers to an optically neutral state, for example, uncolored, transparent or translucent. Still further, unless specified otherwise herein, the “color” of an electrochromic transition is not limited to any particular wavelength or range of wavelengths. As understood by those of skill in the art, the choice of appropriate electrochromic and counter electrode materials governs the relevant optical transition.

Any material having suitable optical, electrical, thermal, and mechanical properties may be used as substrate 102. Such substrates include, for example, glass, plastic, and mirror materials. Suitable plastic substrates include, for example, acrylic, polystyrene, polycarbonate, allyl diglycol carbonate, SAN (styrene acrylonitrile copolymer), poly(4-methyl-1-pentene), polyester, polyamide, etc. If a plastic substrate is used, it is preferably barrier protected and abrasion protected using a hard coat of, for example, a diamond-like protection coating, a silica/silicone anti-abrasion coating, or the like, such as is well known in the plastic glazing art. Suitable glasses include either clear or tinted soda lime glass, including soda lime float glass. The glass may be untempered, strengthened (heat or chemically) or tempered. An electrochromic device with glass, for example, soda lime glass, used as a substrate may include a sodium diffusion barrier layer between the soda glass and the device to prevent diffusion of sodium ions from the glass into the device. Both glass and plastic substrates are compatible with embodiments described herein, so long as their properties are accounted for in the described methods. This is explained in further detail below.

FIG. 1B is a schematic cross-section of electrochromic device 100 shown in FIG. 1A but in a colored state (or transitioning to a colored state). In FIG. 1B, the polarity of voltage source 116 is reversed, so that the electrochromic layer is made more negative to accept additional lithium ions, and thereby transition to the colored state; at the same time, lithium ions leave the counter electrode or ion storage layer 110, and it also colors. As indicated by the dashed arrow, lithium ions are transported across ion conductor layer 108 to electrochromic layer 106. Exemplary materials that color complimentarily in this fashion are tungsten oxide (electrochromic layer) and nickel-tungsten oxide (counter electrode layer).

Certain electrochromic devices may include reflective materials in one or both electrodes in the device. For example, an electrochromic device may have one electrode that colors anodically and one electrode that becomes reflective cathodically. Such devices are compatible with embodiments described herein so long as the reflective nature of the device is taken into account. This is explained in more detail below.

The all solid state and inorganic electrochromic devices described above have low defectivity and high reliability, and thus are well suited for electrochromic windows, particularly those with large format architectural glass substrates.

Not all electrochromic devices have a distinct ion conductor layer as depicted in FIGS. 1A and 1B. As conventionally understood, the ionically conductive layer prevents shorting between the electrochromic layer and the counter electrode layer. The ionically conductive layer allows the electrochromic and counter electrode layers to hold a charge and thereby maintain their bleached or colored states. In electrochromic devices having distinct layers, the components form a stack which includes the ion conductor layer sandwiched between the electrochromic layer and the counter electrode layer. The boundaries between these three stack components are defined by abrupt changes in composition and/or microstructure. Thus, such devices have three distinct layers with two abrupt interfaces.

Quite surprisingly, it has been discovered that high quality electrochromic devices can be fabricated without depositing an ionically conducting electrically insulating layer. In accordance with certain embodiments, the counter electrode and electrochromic layers are formed immediately adjacent one another, often in direct contact, without separately depositing an ionically conducting layer. It is believed that various fabrication processes and/or physical or chemical mechanisms produce an interfacial region between contacting electrochromic and counter electrode layers, and that this interfacial region serves at least some functions of an ionically conductive electronically insulating layer as in devices having such a distinct layer. Such devices, and methods of fabricating them, are described in U.S. patent applications, Ser. No. 12/772,055 (now U.S. Pat. No. 8,300,298) and Ser. No. 12/772,075, each filed on Apr. 30, 2010, and in U.S. patent application Ser. Nos. 12/814,277 and 12/814,279, each filed on Jun. 11, 2010—each of the four applications is entitled “Electrochromic Devices,” each names Zhongchun Wang et al. as inventors, and each is incorporated by reference herein for all purposes. A brief description of these devices follows.

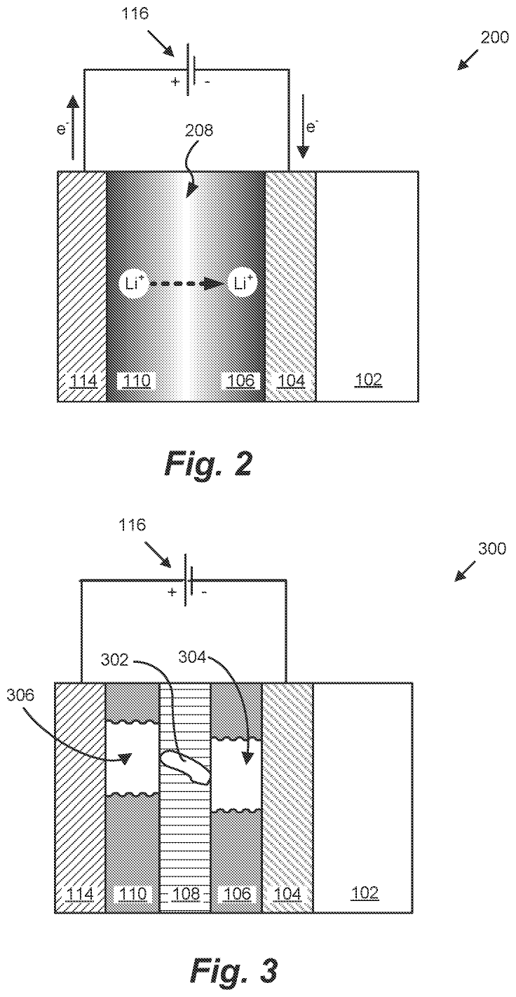

FIG. 2 is a schematic cross-section of an electrochromic device, 200, in a colored state, where the device has an ion conducting electronically insulating interfacial region, 208, serving the function of a distinct IC layer. Voltage source 116, conductive layers 114 and 104, and substrate 102 are essentially the same as described in relation to FIGS. 1A and 1B. Between conductive layers 114 and 104 is graded region, which includes counter electrode layer 110, electrochromic layer 106, and an ion conducting electronically insulating interfacial region, 208, between them, rather than a distinct IC layer. In this example, there is no distinct boundary between counter electrode layer 110 and interfacial region 208, nor is there a distinct boundary between electrochromic layer 106 and interfacial region 208. Collectively, regions 110, 208 and 106 may be thought of as a continuous graded region. There is a diffuse transition between CE layer 110 and interfacial region 208, and between interfacial region 208 and EC layer 106. These devices may be thought of as “no IC layer” devices. Conventional wisdom was that each of the three layers should be laid down as distinct, uniformly deposited, and smooth layers to form a stack. The interface between each layer should be “clean” where there is little intermixing of materials from each layer at the interface. One of ordinary skill in the art would recognize that in a practical sense there is inevitably some degree of material mixing at layer interfaces, but the point is, in conventional fabrication methods any such mixing is unintentional and minimal. The inventors of this technology found that interfacial regions serving as IC layers can be formed where the interfacial region includes significant quantities of one or more electrochromic and/or counter electrode materials by design. This is a radical departure from conventional fabrication methods. However, as in conventional electrochromic devices, shorting can occur across the interfacial region. Various methods described herein are applicable to devices having such interfacial regions, rather than IC layers.

The all solid state and inorganic electrochromic devices described above have low defectivity and high reliability. However, defects can still occur. For context, visually discernible defects in electrochromic devices are described below in relation to conventional layered stack type electrochromic devices so as to more fully understand the nature of the disclosed embodiments.

### II. Visible Defects in Electrochromic Devices

As used herein, the term “defect” refers to a defective point or region of an electrochromic device. Defects may be characterized as visible or non-visible. Often a defect will be manifest as a visually discernible anomaly in the electrochromic window or other device. Such defects are referred to herein as “visible” defects. Typically, these defects are visible when the electrochromic device is transitioned to the tinted state due to the contrast between the normally operating device area and an area that is not functioning properly, e.g., there is more light coming through the device in the area of the defect. Other defects are so small that they are not visually noticeable to the observer in normal use. For example, such defects do not produce a noticeable light point when the device is in the colored state during daytime. A “short” is a localized electronically conductive pathway spanning the ion conductor layer or region (supra), for example, an electronically conductive pathway between the two transparent conductive oxide layers.

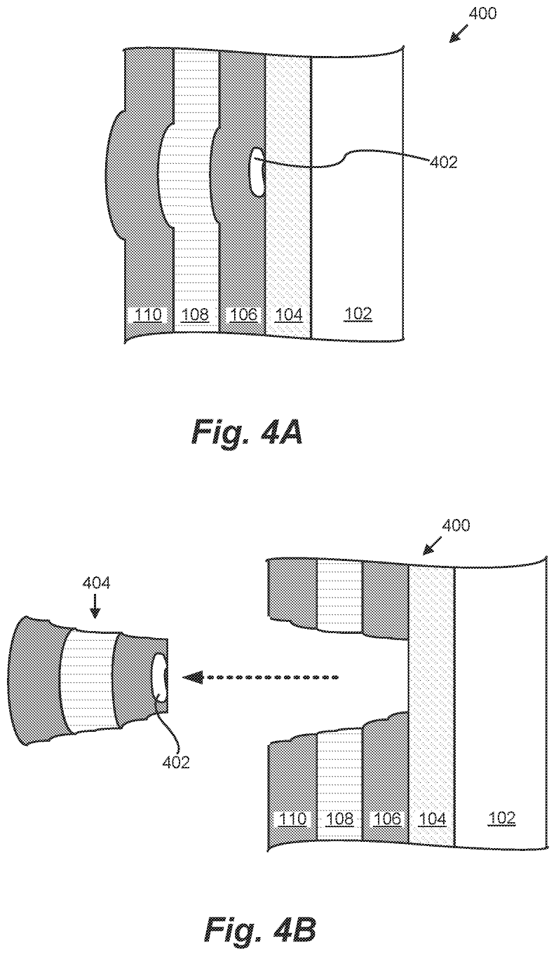

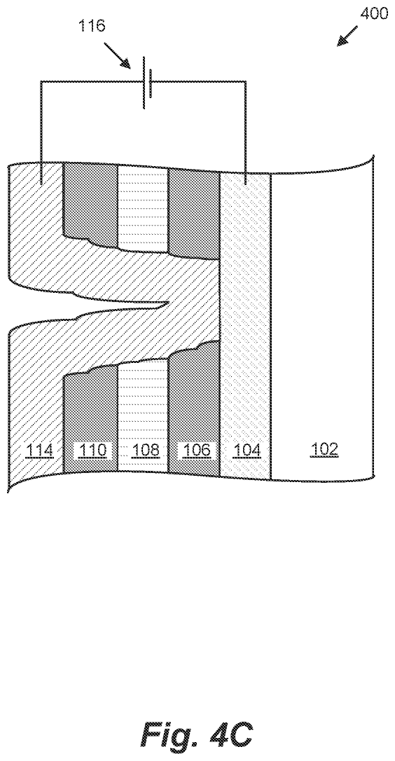

In some cases, an electrical short is created by an electrically-conductive particle spanning the ion conductor layer, thereby causing an electronic path between the counter electrode and the electrochromic layer or the TCO associated with either one of them. In some other cases, a defect is caused by a particle on the substrate (on which the electrochromic stack is fabricated) and such a particle causes layer delamination (sometimes called “pop-off”) where the layers do not adhere properly to the substrate. Delamination of layers can also occur without association with a particle contaminant and may be associated with an electrical short, and thus a halo. A delamination or pop-off defect can lead to a short if it occurs before a TCO or associated EC or CE is deposited. In such cases, the subsequently deposited TCO or EC/CE layer will directly contact an underlying TCO or CE/EC layer providing direct electronic conductive pathway. Particle related defects are illustrated below in FIGS. 3 and 4A-4C.

FIG. 3 is a schematic cross-section of an electrochromic device, 300, with a particle, 302, in and spanning the ion conductor layer causing a localized shorting defect in the device. Device 300 is depicted with typical distinct layers, although particles in this size regime would cause visual defects in electrochromic devices employing ion conducting electronically insulating interfacial regions as well. Electrochromic device 300 includes the same components as depicted in FIG. 1A for electrochromic device 100. In ion conductor layer 108 of electrochromic device 300, however, there is conductive particle 302 or other artifact causing a defect. Conductive particle 302 results in a short between electrochromic layer 106 and counter electrode layer 110. This short affects the device locally in two ways: 1) it physically blocks the flow of ions between electrochromic layer 106 and counter electrode layer 110, and 2) it provides an electrically conductive path for electrons to pass locally between the layers, resulting in a transparent region 304 in the electrochromic layer 106 and a transparent region 306 in the counter electrode layer 110, when the remainder of layers 110 and 106 are in the colored state. That is, if electrochromic device 300 is in the colored state, where both electrochromic layer 106 and ion storage layer 110 are supposed to be colored, conductive particle 302 renders regions 304 and 306 of the electrochromic device unable to enter into the colored state. These defect regions are sometimes referred to as “halos” or “constellations” because they appear as a series of bright spots or stars against a dark background (the remainder of the device being in the colored state). Humans will naturally direct their attention to halos due to the high contrast of halos against a colored window and often find them distracting and/or unattractive. As mentioned above, visible shorts can be formed in other ways.

FIG. 4A is a schematic cross-section of an electrochromic device, 400, with a particle, 402, or other debris on conductive layer 104 prior to depositing the remainder of the electrochromic stack. Electrochromic device 400 includes the same components as electrochromic device 100. Particle 402 causes the layers in electrochromic stack to bulge in the region of particle 402, due to conformal layers 106-110 being deposited sequentially over particle 402 as depicted (in this example, transparent conductor layer 114 has not yet been deposited). While not wishing to be bound by a particular theory, it is believed that layering over such particles, given the relatively thin nature of the layers, can cause stress in the area where the bulges are formed. More particularly, in each layer, around the perimeter of the bulged region, there can be defects in the layer, for example, in the lattice arrangement, or on a more macroscopic level, cracks or voids. One consequence of these defects would be, for example, an electrical short between electrochromic layer 106 and counter electrode layer 110 or loss of ion conductivity in layer 108. These defects are not depicted in FIG. 4A, however.

Referring to FIG. 4B, another consequence of defects caused by particle 402 is called a “pop-off.” In this example, prior to deposition of conductive layer 114, a portion above the conductive layer 104 in the region of particle 402 breaks loose, carrying with it portions of electrochromic layer 106, ion conductor layer 108, and counter electrode layer 110. The “pop-off” is piece 404, which includes particle 402, a portion of electrochromic layer 106, as well as ion conductor layer 108 and counter electrode layer 110. The result is an exposed area of conductive layer 104.

Referring to FIG. 4C, after the pop-off of piece 404 and once conductive layer 114 is deposited, an electrical short is formed where conductive layer 114 comes in contact with conductive layer 104. This electrical short would leave a transparent region or halo in electrochromic device 400 when it is in the colored state, similar in appearance to the defect created by the short described above in relation to FIG. 3.

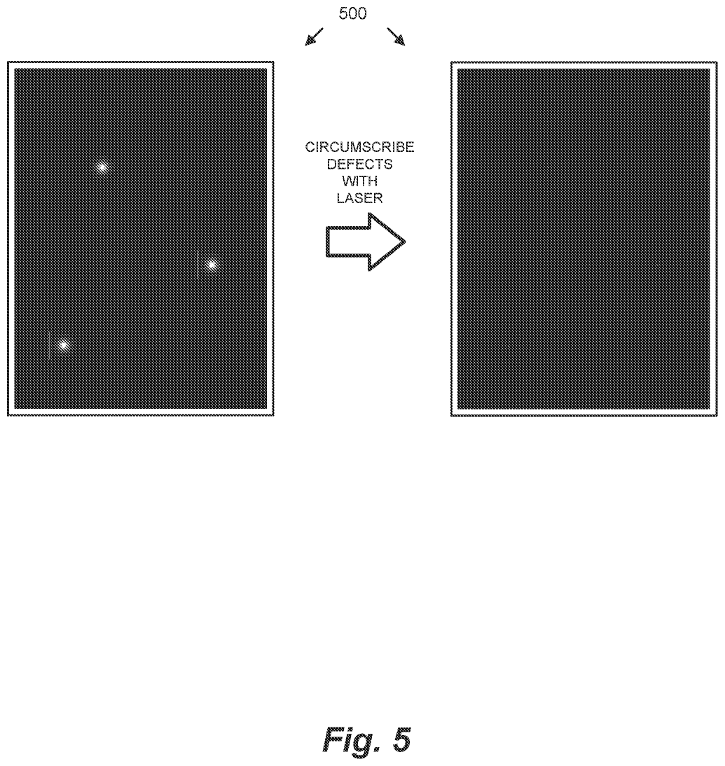

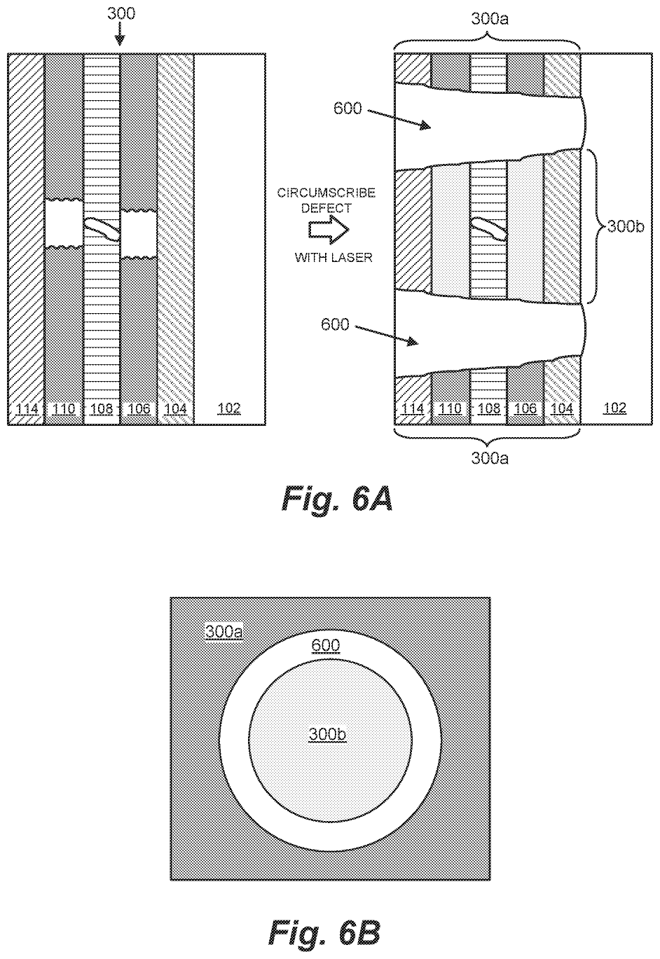

A typical defect causing a visible short may have a physical dimension of about 3 micrometers (sometimes smaller or larger, however) which is a relatively small defect from a visual perspective. However, these relatively small defects result in a visual anomaly, the halo, in the colored electrochromic window that are, for example, about 1 cm in diameter, and sometimes larger. Halos can be reduced significantly by isolating the defect, for example circumscribing the defect via laser scribe or by ablating the material directly without circumscribing it. For example, a circular, oval, triangular, rectangular, or other shaped perimeter is ablated around the shorting defect thus electrically isolating it from the rest of the functioning device (see also FIGS. 5 and 6 and associated description). The circumscription may be only tens, a hundred, or up to a few hundred microns in diameter. By circumscribing, and thus electrically isolating the defect, what was the visible short will now resemble only a small point of light to the naked eye when the window is colored and there is sufficient light on the other side of the window. When ablated directly, without circumscription, there remains no EC device material in the area where the electrical short defect once resided. Rather, there is a hole in the device and the base of the hole is, e.g., the float glass, the diffusion barrier, the lower transparent electrode material, or a mixture thereof. Since these materials are all transparent, light may pass through the base of the hole in the device, again, appearing only as a small point of light.

One problem with ablating a defect directly is that there is a chance that there will be further shorting issues, e.g., a metallic particle could be melted, with its size increased relative its size to prior to ablation. This could cause further shorting. For this reason, it is often useful to circumscribe defects, leaving a “buffer zone” of non-defective device around the defect (see FIGS. 6A and 6B and associated description). Depending on the diameter of a circumscribed defect, and the width of the laser beam, circumscribed pinholes may have some EC material, or not, remaining within the circumscription (the circumscription is typically, though not necessarily, made as small as possible). Such mitigated short defects may be manifest as pin points of light against the colored device, thus these points of light are commonly referred to as “pinholes.” Isolation of an electrical short by circumscribing would be an example of a man-made pinhole, one purposely formed to convert a halo into a much smaller visual defect. However, pinholes may also arise as a natural result of defects in the optical device.

A pinhole is a region where one or more layers of the electrochromic device are missing or damaged so that electrochromism is not exhibited. Pinholes are not electrical shorts, and, as described above, they may be the result of mitigating an electrical short in the device. A pinhole may have a defect dimension of between about 25 micrometers and about 300 micrometers, typically between about 50 micrometers and about 150 micrometers, and thus is much harder to discern visually than a halo. In order to reduce the visible perception of pinholes resulting from the mitigation of halos, in certain embodiments the size of a purposely-created pinhole is minimized. In one embodiment, a laser ablation circumscription has an average diameter of about 400 micrometers or less, in another embodiment about 300 micrometers or less, in another embodiment about 200 micrometers or less, and in yet another embodiment about 100 micrometers or less. Depending upon the end user, pinholes on the larger side of this size regime tend not to be noticeable. If possible, laser ablation circumscriptions are made on the smaller side of this size regime, e.g., about 200 micrometers or less.

### III. Circumscription of Visual Defects

FIG. 5 depicts an electrochromic lite, 500, having three halo shorting type defects (left) in the viewable area of the lite while the lite is in the colored state. The lite on the left of FIG. 5 shows the halos prior to mitigation. The defects show up as constellations or halos, sometimes on the scale of centimeters in diameter. Thus, they are visually distracting and unappealing to the viewer. The lite on the right depicts the same electrical short defects causing the three halos, after they have been circumscribed to form pinholes. It is apparent that pinholes are favorable to halos. However, oftentimes defects that are laser circumscribed in a conventional way do not cleanly form pinholes, that is, the pinholes are often electrically leaky and thus are not “clean” pinholes. In such cases, leakage causes the pinholes to resemble halos over time. The inventors have discovered the reason for this problem and have developed methods of overcoming it.

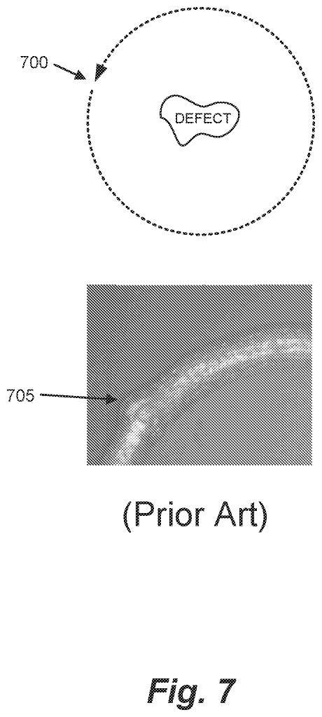

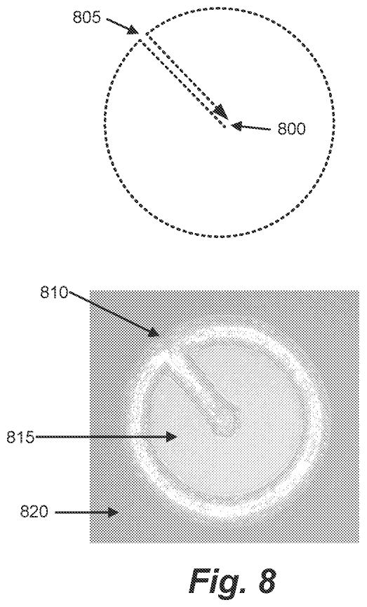

The left-hand portion of FIG. 6A depicts a cross section of device 300, as described in relation to FIG. 3, which has a conductive particle spanning ion conductor layer 108. Device 300 is in a colored state, but the electrical short from the particle creates non-colored regions in the electrochromic and counter electrode layers, 106 and 110, respectively. Referring to the right-hand portion of FIG. 6A, when the particle causing this visual anomaly is circumscribed, e.g., while device 300 remains in the colored state, a continuous trench, 600, is formed around the particle as well as some of the device stack. Trench 600 isolates a portion, 300b, of device 300 from the bulk device, 300a. FIG. 6B shows this laser isolation scribe from a top view (for simplicity the shorting particle is not shown). Ideally this laser ablation electrically isolates material 300b from the bulk device 300a. So, the device material remaining within trench 600 does not color, but does have some absorptive properties and is thus slightly more colored than substrate 102 at the bottom of trench 600. However, as described above, this electrical isolation is not always so clean as depicted in FIGS. 6A and 6B. This is explained in more detail in relation to FIG. 7.

Laser isolation need not penetrate all the layers of the device stack, e.g., as depicted in FIGS. 6A and 6B. The laser can penetrate any depth from removing the outer layer (e.g., 114) to the full stack, and any depth in between. For example, the laser need only penetrate one of the transparent conductor layers (104 or 114) in order to electrically isolate the stack material within the perimeter of the scribe. The scribe may penetrate one, two, three, four or all five layers of the device (having five layers). In devices that have graded compositions rather than distinct layers, e.g., an electrochromic device as described in association with FIG. 2, penetration of the entire device structure may be necessary.

Referring to FIG. 7, conventional laser circumscription methods employ a “closed” perimeter scribe. The closed perimeter could be of any shape, but for convenience circular perimeters are described herein. That is, the laser is applied to a local region or spot, 700, chosen at some distance from a defect. The laser is applied around the defect in a closed pattern, e.g., a circle, where the laser begins ablation at spot 700 and ends at spot 700; that is, the beginning and ending position of the laser is substantially the same or at least there is some overlap of the area of the laser focus and/or width of the laser scribe at the beginning and ending positions. “Overlap” in this description refers to the overlapping of the area of the laser focus and/or width of the laser scribe created by the laser path, and how this area or width is overlapped by the laser during ablation. For example, if the laser is focused on a first position and then again on this same position at the end of the laser path, then this is 100% overlap. If, however, the laser is focused on the first position and then on a second position that is moved a distance equal to the radius of the focal point, then this is 50% overlap.

This type of closed pattern, where the start and end point overlap each other and are part of the perimeter thus formed, creates further problems. Although it isolates the defect within it, perimeters formed in this way have problems in the region where the ablation start and end overlap each other. That is, for any particular device, a particular fluence (energy delivered per unit area) is chosen such that it is enough to ablate the device layers and effectively electrically isolate one area of the device from another. This is effective for the majority of the perimeter region when a defect is circumscribed, but in the area where the laser starts, and where the start and finish overlap each other, there is often excessive energy which results in stack melting and electrical shorting of the film stack in that area. This is particularly true of the point where the laser starts. There is a transient energy flux created when the laser is energized. This excess energy is imparted to the device when the laser first strikes the device. This is depicted in a micrograph in FIG. 7 (bottom) of a portion of an actual laser circumscription, showing that the width of the circumscription is wider at a point, 705, where the laser started and finished the perimeter around a defect (in this example the overlap of starting and stopping point was 40%). It is at this point where further shorting occurs. In order to avoid this issue, a lower fluence may be selected, but that often results in insufficient ablation of the film around the remainder of the perimeter. Embodiments described herein overcome these problems, e.g., by creating an ablation perimeter where the fluence is sufficient to electrically isolate the shorting defect, while substantially uniform about the ablation perimeter.

One method to overcome the above-described problem of excess energy due to the transient flux during laser energizing is to shutter the laser beam until it reaches steady state energy level and then to apply the laser to the circumscription pattern. In this way excess energy can be avoided. One embodiment is a method of forming a laser ablation perimeter surrounding a defect in an optical device, the method including: a) energizing a laser while the laser beam is shuttered; b) allowing the laser to reach a steady state energy level; and c) circumscribing the defect with the laser. This method may be used with any circumscription pattern described herein, because the issue of excessive energy is avoided by use of the shutter. For example, a conventional closed pattern as described in relation to FIG. 7 may suffice when using this method.

Another method to overcome the above-described problem of excess energy is to make a conventional perimeter, but to overlap the starting and ending positions of the laser beam only enough so as to close the perimeter but not create excess energy (e.g., to minimize melting and shorting created thereby); the smaller the overlap, the smaller the portion of the device that may have shorting due to excess energy. Because the overlap is minimized, high precision is necessary to ensure both complete closure of the perimeter (to ensure electrical isolation) as well as minimum damage due to excess energy in the overlap region (thus causing electrical shorts). One embodiment is a method of forming a laser ablation perimeter surrounding a defect in an optical device, the method including forming the laser ablation perimeter without complete overlap of both the starting and the stopping the laser beam positions, wherein the overlap of the starting and stopping positions is less than about 25%. In one embodiment the overlap of the starting and stopping positions is less than about 10%, and in another embodiment, less than about 5%. However, this method may need more adjustments than other methods described below, as excess energy may occur with the transient energy flux at laser startup; e.g., overlapping of the start and finish points may be irrelevant because the start point itself may cause excessive fluence. Other embodiments compensate for this, as described below.

In one embodiment, laser circumscription is performed in a closed pattern as in a conventional sense described above, with greater than about 25% overlap of starting and stopping positions, but where a process window is chosen such that lower fluence is used at the beginning and end of the circumscription (e.g., during the transient fluence conditions associated with starting and stopping the laser) than over the remainder of the circumscription. That is, the laser circumscription employs a two phase process window, including a transient process condition (at the beginning and/or end of the scribe) and a steady state process condition during the remainder of the laser scribe process. In this embodiment, excessive energy is avoided by lowering the energy delivered at the start and end of the perimeter thus formed, that is, during the transient process condition. One embodiment is a method of forming a laser ablation perimeter surrounding a defect in an optical device, the method including: a) starting application of a laser at a first fluence level in a first region of the laser ablation perimeter; b) translating the laser from the first region to a second region of the laser ablation perimeter, while increasing the fluence level of the laser as it transitions from the first region to the second region: and c) returning the laser to the first region in order to close the perimeter while decreasing the fluence level of the laser, wherein the energy about the laser ablation perimeter is substantially uniform and the overlap of the laser in the first region is at least 25%. By attenuating the fluence at the start and ending positions of the laser, during which otherwise excess energy would result, an ablation perimeter of substantially uniform energy is achieved. Decreasing the fluence level can be achieved, for example, by defocusing the laser, while increasing the fluence can be achieved by focusing the laser. One of ordinary skill in the art would appreciate that other ways of increasing and decreasing the fluence are possible. In other embodiments, laser perimeters are formed without having to change the fluence at any point during formation of the perimeter. These embodiments are described in more detail below.

In certain embodiments, a laser perimeter is formed by starting and/or stopping the scribing process within the perimeter, that is, within the area surrounded by the perimeter. The distance within the perimeter that the starting and/or stopping point is located is chosen so that it is sufficiently far away from the perimeter scribe so there is no excessive energy that would occur otherwise at the perimeter. The starting and stopping point need not be at the same location, but can be. For example, in one embodiment, the scribe starts and ends within the perimeter formed at the center of a circular perimeter. This is depicted in FIG. 8.

The top portion of FIG. 8 depicts a laser scribe pattern. The pattern starts proximate or at the center, 800, of a circular perimeter that is to be formed. The defect is typically located proximate 800. The laser is moved to a position, 805, to form an outer radius, and then a circular pattern is scribed. When the laser reaches point 805, or proximate thereto, it travels back toward the center of the circular pattern, proximate position 800. In this example, excessive energy due to the transient process conditions of starting and ending the laser scribe process are in the center of the perimeter formed, and thus are isolated from the perimeter portion of the pattern. The fluence is chosen to make effective electrical isolation scribes at the perimeter. Proximate position 805, the scribe line may overlap, so long as there is not undue overlap that would otherwise cause electrical shorting as in conventional laser circumscription.

The bottom portion of FIG. 8 shows an actual laser circumscription following the pattern described in the upper portion of FIG. 8 (in this example the pattern is 300 microns in diameter). In this example, the laser line overlaps 90% of the thickness of the line at point 805 and continues inward to stop at position 800. In one embodiment, the overlap is between about 10% and about 100% at some point along the perimeter, e.g., to close the perimeter as in the example described in relation to FIG. 8. In one embodiment, the overlap is between about 25% and about 90%, and in another embodiment, between about 50% and about 90%. In this example, the “dimple,” 810, in the perimeter portion reflects the incomplete (i.e., about 90%) overlap of the line at position 805; if the line had overlapped 100%, there would be no dimple in the circular pattern. Note also that the interior (electrically isolated) portion, 815, of the device does not tint as the bulk device, 820, is tinted. This particular method has the added feature that the starting and stopping point is centered on the defect, so the excess energy is directed to the defect itself. Thus, the coordinates of the defect are used as the start and stop point of the laser pattern to form the perimeter around the defect. The excess energy is contained within the perimeter and thus causes no further shorting; also, this excess energy at the center may aid in making the pinhole created less noticeable as it melts the device materials in that region and may diffuse light better than the defect alone may have done. Also, by having the starting and stopping point at the center, the distance between the perimeter formed and the excess energy spot is maximized in all directions.

By using patterns such as described in relation to FIG. 8, any transient effects resulting in excess energy are contained within the perimeter region and thus do not cause further electrical shorting. Put another way, a highly uniform perimeter portion of a scribe is formed, i.e., without any excess fluence along the perimeter portion of the scribe. By isolating portions of excess energy from the perimeter portion of the scribe, the scribe process can be adjusted for good steady state conditions, dramatically widening the range of acceptable parameter settings that result in effective and uniform electrical isolation about the perimeter portion of the scribe. For example, fluence levels can be set at higher values to allow adequate steady state scribing, while isolating excessive energy (from starting and stopping the laser) within the perimeter region.

In some embodiments, the starting point of the laser focus is located near or at the defect (e.g., a pinhole defect). By starting the laser focus at this location, the laser can at least partially, if not entirely, mitigate the defect by vaporize the materials in a region at or near the defect before the laser focus is moved to another location along the ablation perimeter. Vaporizing the materials in this region may diffuse light better than if the defect were only circumscribed. An exemplary method of forming a laser ablation perimeter about a defect in an optical device includes: a) starting application of a laser with a laser focus at a first position located proximate the defect; b) at least partially mitigating the defect; c) moving the laser focus from the first position to a second position that is part of the laser ablation perimeter; d) moving the laser focus along the laser ablation perimeter until the laser focus is proximate the second position; and e) closing the laser ablation perimeter. In some cases, closing the laser ablation perimeter includes overlapping the laser focus at the second position. The overlapping of the second position is as described above in relation to FIG. 8. In one case, the method also includes moving the laser focus to a position within the area surrounded by the laser ablation perimeter. In another case, returning the laser to within the area surrounded by the laser ablation perimeter includes returning the laser focus proximate the first position.

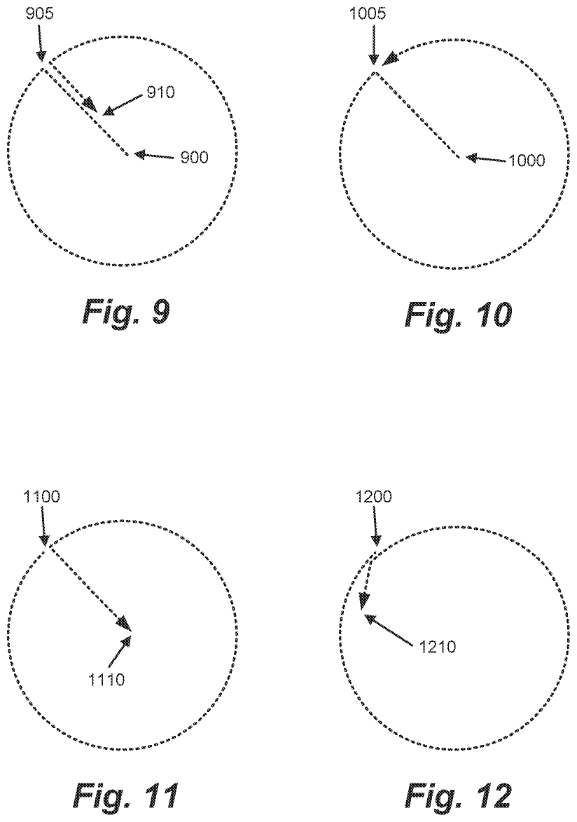

One embodiment is a method of forming a laser ablation perimeter about a defect in an optical device including: a) starting application of a laser at a first position, within an area that will be surrounded by the laser ablation perimeter; b) translating the laser focus from the first position to a second position, the second position being a part of the laser ablation perimeter; c) translating the laser about the defect until the laser focus is proximate the second position; d) closing the laser ablation perimeter by overlapping the second position with the laser focus; and e) returning the laser to a position within the area surrounded by the laser ablation perimeter. The laser is stopped after e). The overlapping of the second position is as described above in relation to FIG. 8. In one case, returning the laser to the area surrounded by the laser ablation perimeter includes returning the laser to the first position and stopping the ablation. In another case, the laser is stopped at a third position, within the area surrounded by the perimeter. One example of this is described in relation to FIG. 9.

FIG. 9 shows a pattern, similar to that described in relation to FIG. 8. In this pattern, the laser ablation starts at position 900, moves along a line to position 905 to form a radius, then circles counterclockwise (in this example, but clockwise would work) until reaching 905, where there is overlap as described above. Then the laser moves to position 910, within the interior of the perimeter portion of the scribe. In this example, the laser stops short of position 900 at the end of the scribe process. This is an example of the laser start and stop positions being different, but both inside the perimeter portion of the scribe.

FIG. 10 shows a pattern, similar to that described in relation to FIG. 8. In this pattern, the laser ablation starts at position 1000, moves along a line to position 1005 to form a radius, and then circles counterclockwise until reaching 1005, where there is overlap as described above. In this example, the laser stops proximate, or on, position 1005 at the end of the scribe process. This is an example of the laser start being inside the perimeter portion of the scribe with the laser end position being part of the perimeter portion of the scribe. By choice of the start position of the laser and by avoiding any overlap of start and stopping positions, there is no excessive energy in the perimeter portion of the scribe.

One embodiment is a method of forming a laser ablation perimeter about a defect in an optical device including: a) starting application of a laser at a first position, within the area that will be surrounded by the laser ablation perimeter; b) translating the laser from the first position to a second position, the second position being a part of the laser ablation perimeter; c) translating the laser about the defect until the laser focus is proximate the second position; and d) closing the laser ablation perimeter by overlapping the second position with the laser focus, wherein the closure position is also the stopping position of the laser. The overlap is as described above with respect to FIG. 8.

FIG. 11 shows a pattern, similar to that described in relation to FIG. 8. In this pattern, the laser ablation starts at position 1100, moves counterclockwise along a circular path until reaching 1100, where there is overlap as described above with respect to FIG. 8. Then the laser moves to position 1110, within the perimeter portion of the scribe. This is an example of the laser start being part of the perimeter portion of the scribe while the laser end position is within the perimeter portion of the scribe. In this example, since the start position is part of the perimeter region, careful choice of laser energy may be required.

One embodiment is a method of forming a laser ablation perimeter about a defect in an optical device including: a) starting application of a laser at a first position, within the line that will define the laser ablation perimeter; b) translating the laser about the defect until the laser focus is proximate the first position; c) closing the laser ablation perimeter by overlapping the laser focus with the first position; and d) moving the laser to within the area surrounded by the laser ablation perimeter. The overlap is as described above with respect to FIG. 8. In one embodiment, d) further includes moving the laser to the center of the perimeter. In another embodiment, d) further includes moving the laser inside the first position in a spiral pattern, at least some overlap occurring in the spiral pattern. An example of this latter embodiment is described in relation to a specific example in FIG. 12.

FIG. 12 shows a pattern, similar to that described in relation to FIG. 8. In this pattern, the laser ablation starts at position 1200, moves counterclockwise along a substantially circular path until coming close to position 1200. In this example, the laser focus is brought close to the starting position, but spirals inward, so that there is some overlap of the ablation focus to close the perimeter, but not create excess energy proximate position 1200. The overlap is as described above with respect to FIG. 8. In this example, since the start position is part of the perimeter region, careful choice of laser energy may be required. In the example depicted, the laser is brought to point 1210; however the laser could stop prior to this position so long as the perimeter is closed by the overlap described. This is an example of the laser start being part of the perimeter portion of the scribe while the laser end position is within the perimeter portion of the scribe. Since there is not overlap of both the beginning and ending transients of the laser, there is not excessive energy.

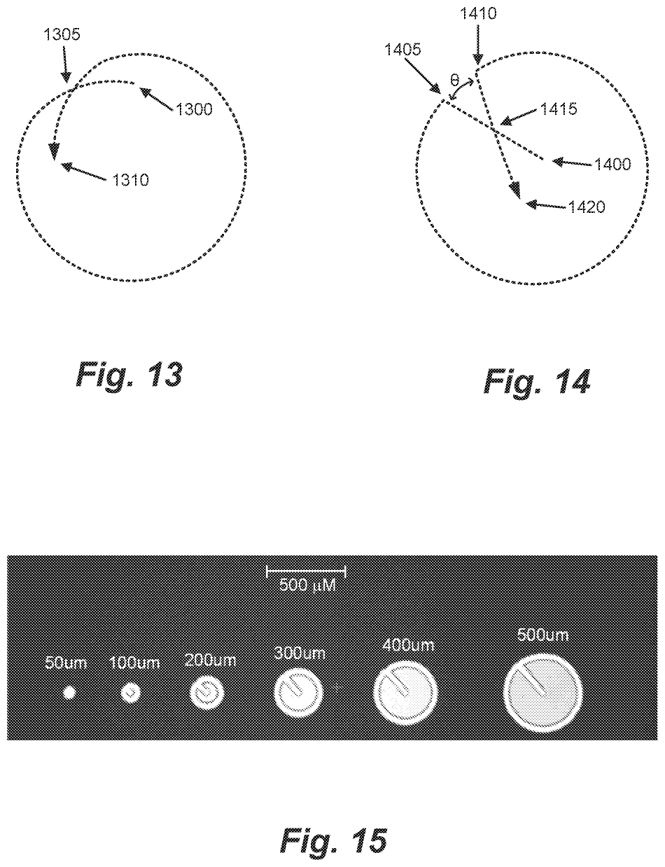

FIG. 13 shows a pattern, similar to that described in relation to FIG. 12. In this pattern, the laser ablation starts at position 1300, moves counterclockwise along a substantially circular path until spiraling inward to cross at a point, 1305, and finally ending at point 1310. In this example, there is 100% overlap at crossing point 1305, but both the start and stop positions are within the perimeter portion of the scribe pattern, therefore excess energy is avoided.

One embodiment is a method of forming a laser ablation perimeter surrounding a defect in an optical device, the method including: a) starting application of a laser at a starting position, within the area that will be surrounded by the laser ablation perimeter; b) translating the laser from the first position and about the defect until the laser focus crosses its own path, but not at the starting position. The laser may be stopped at the crossing point or once past the crossing point.

FIG. 14 shows a pattern, similar to that described in relation to FIG. 13. In this pattern, the laser ablation starts at position 1400, moves outward along a radius to position 1405, then runs counterclockwise along a substantially circular path until reaching a third point, 1410, the runs inward along a radius, crossing the first radius at point 1415 and finally ending at point 1420. In this example, there is 100% overlap at crossing point 1415, but both the start and stop positions are within the perimeter portion of the scribe pattern, therefore excess energy is avoided. Also, another feature of this pattern is that since the angle θ is acute, there is gradually increasing overlap between the lines prior to the full intersection point 1415. This gradual overlap assures that the region of the perimeter of the scribe proximate intersection 1415 does not have excessive energy, as the point of maximum overlap, 1415, is not the exterior-most portion of the scribe line, but rather is a gradient of overlap starting from lower to higher overlap.

One embodiment is a method of forming a laser ablation perimeter surrounding a defect in an optical device, the method including: a) starting application of a laser at a first position, within the area that will be surrounded by the laser ablation perimeter; b) translating the laser from the first position to a second position, the second position being a part of the laser ablation perimeter; c) translating the laser about the defect until the laser focus crosses its own path, between the first and second position. The laser may be stopped at the crossing point or once past the crossing point.

### EXAMPLE

Laser ablation perimeters were formed in an electrochromic device using the pattern described in relation to FIG. 8 in comparison to a conventional laser ablation perimeter. The laser perimeter was ablated using a fluence of 1.6 J/cm2 using 90% overlap of the laser lines starting at the point on the perimeter where the lines meet in order to close the perimeter and continuing on to the center of the perimeter where the laser ablation also started. Perimeters of 50, 100, 200, 300, 400 and 500 microns were formed. The actual patterns are shown in FIG. 15. FIG. 15 shows the colored electrochromic device with the laser scribe patterns arranged thereon. As shown, the device remaining in the interior region of the perimeter is not colored as in the bulk device surrounding the perimeters. Further testing showed that the 50 microns pattern did show some leakage, but this was likely the result of the geometrical limitation due to the size of the laser focal point as compared to the pattern size. If a smaller focal point is used, then smaller patterns, such as 50 microns in diameter, are likely to work just as well as the larger sized patterns.

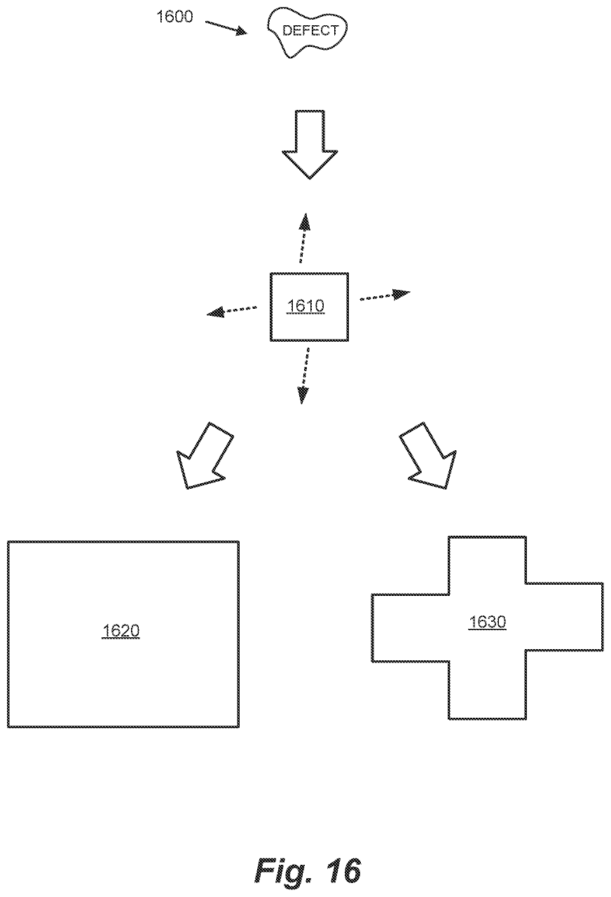

One embodiment is a method of ablating a defect (e.g., pinhole or short-related defect) with a laser focus spot that first locates the focus spot at or near the defect and then moves the focus spot to ablate over an ablation area that includes the defect area. This may be conveniently done by first focusing the laser at a location at or near the center of the defect, but the method does not necessarily need to do so. In some cases, the focus spot may be moved in such a way to cover one or more regions. These regions may overlap each other in some cases. A rasterizer may be used to move the focus spot over the one or more regions. The ablated area need not be a regular shape. The ablated area can be in the form of, for example, a circle, a rectangle, sawtooth pattern, a cross shape, or other shape. FIG. 16 shows a schematic drawing illustrating this method. In this illustrated example, a laser focus spot 1610 is first located at or near a defect 1600. The focus spot 1610 can be moved in any direction (as illustrated by the arrows) to ablate over an area that includes the defect area. Two examples of shapes of ablated areas are shown. The first example is a rectangular ablated area 1620. The second example is a cross pattern ablated area 1630. In some cases, the focus spot may be moved in one or more regions that make up the ablated area.

### IV. Methods of Defining a Polygon Laser Ablation Pattern

Certain circumscription techniques are designed to mitigate a defect in an optical device by completely encapsulating and isolating the defect from the surrounding area using a circular laser ablation pattern to circumscribe around the defect. These circumscription techniques may be limited with respect to how small the circular pattern used to encapsulate the affected area can be. For example, if there is an elongated defect in the device, these circumscription techniques may scribe a circular area with a diameter based on the longest dimension of the defect. For instance, if an elongated defect is 600 μm in length and 10 μm in width, the circumscription procedure may scribe using a 650 μm radius circular pattern around the defect based on its length. A pinhole created using a 650 μm circular pattern could potentially be visible from 10 inches away from the tinted optical device lite, which might be considered objectionable if this pinhole were visible in the viewable area of the lite. In this instance, mitigation of this elongated defect using these circumscription techniques might result in the lite being unusable even though 99.9% of the visible surface area is defect free. Another example where circumscription techniques may have limitations as to the size of the circular pattern is with respect to a debris field of particles or other group of defects spread across the viewable area. To mitigate multiple defects in the device either a single, circular pattern is used to circumscribe all the defects or multiple circular patterns are used to circumscribe around individual defects respectively leaving multiple pinholes. Where multiple circular pattern scribes are used to de-activate individual defects, e.g., caused by particles, a larger deactivated area is created than the area covered by the particles themselves, resulting in unnecessary yield loss in the functional optical device. Moreover, ASTM standards have restrictions on the number of permissible pinholes within a certain distance of each other in the viewable area of an optical device lite (e.g., electrochromic lite).

Certain embodiments described herein are directed to methods of mitigating one or more defects (e.g., electrical shorts or any other aesthetically unpleasing defects) that includes a technique for generating a polygon ablation pattern based on a polygon boundary defined around one or more defect areas in an image of a tinted optical device lite. The polygon boundary is a map of co-ordinates for use in directing the laser spot to ablate one or more defects in the optical device lite, e.g., in the viewable area of the lite. The co-ordinates of the polygon boundary may be defined, e.g., to minimize the deactivated area from mitigation using the polygon ablation pattern. This technique for generating the polygon ablation pattern may enable a way of mitigating different types of defect shapes without having to use circumscription to create a large pinhole or multiple pinholes in the optical device that might be objectionable otherwise. The polygon boundary is adapted to the shape of a defect or a cluster of defects. The polygon boundary may be, for example, a triangle, a four-segment strip (e.g., rectangular or parallelogram), or a polygon with four or more segments in directions adapted to the shape of the defect or a cluster of defects. The polygon ablation pattern technique may enable the repair of a multitude of different defect types such as, e.g., scratches, scattered particle debris field, elongated clusters of particles, etc.

In certain aspects, the polygon ablation pattern technique employs imaging processing techniques. One or more images may be taken of the lite while the optical device is in a darkened tint state, for example. In some cases, back lit illumination (also referred to herein as “back light illumination”) is provided from the opposite side of the lite to provide background light transmitted through any areas (i.e. areas where the optical device is not tinting or is less than fully tinting to the darkened tint state) to increase the intensity of the bright areas in the image. The image may be captured using a microscopic camera or other image capturing device, e.g., mounted to an x-y stage to enable movement of the device to image different regions of the lite. In another example a non-optical image such as an infrared camera image can be taken of the lite. In the case of an infrared image, the “brightest spot” on the infrared image will correspond to the “hottest spot.”

In one aspect, imaging processing techniques are used to determine a polygon boundary for a polygon ablation pattern that would allow for the smallest deactivated area. The one or more defects may be mitigated using the polygon ablation pattern by directing a laser spot to follow a path along the polygon boundary and/or scan the laser spot across a region within the polygon boundary. For example, a laser controller may be programmed with instructions that cause the laser spot to follow the path along the polygon boundary determined by one or more imaging processing techniques. The laser spot may scan over a region within the polygon boundary by means of raster scanning or other coordinated movements, e.g., of an x-y stage or x-y stages upon which the optical device lite and/or the laser is mounted.

Certain embodiments pertain to methods of determining a polygon laser ablation pattern that can be used to mitigate one or more defects in an optical device lite. These methods employ imaging processing techniques to analyze one or more images of the optical device (e.g., electrochromic device) while tinted. Some examples of image processing techniques that can be used include image intensity gradient determination, image filtering, image thresholding, image cleaning, and morphological operations.

In certain aspects, a method of determining a polygon ablation pattern includes: (1) identifying spatial coordinates (e.g., coordinates of any spatial co-ordinate system including, e.g., cartesian, polar, or other coordinates) of a source or sources of one or more defects (e.g., electrical short or other aesthetically unpleasing defect) in an optical device lite; (2) defining a region of interest (ROI) around a center of one of the defect areas; and (3) determining a polygon ablation pattern by defining a polygon boundary (mapping of coordinates) based on a boundary around one defect area or a combined boundary around a cluster of defect areas in the ROI. The polygon boundary may be defined to minimize the area within to reduce the deactivated area that will result from laser scribing along the polygon boundary and/or scanning a laser spot across the area within the polygon boundary. In one aspect, the method includes identifying a region of the one or more defects by analyzing a first image taken of the entire viewable area of the optical device lite while the optical device is tinted and then taking a second image focused on the local region with the one or more defects. The second image may be of higher resolution than the first image. Alternatively, the tinted optical device lite may be visually inspected to locate the local region with visually-discernable bright areas or areas that are darker than the tint state.

Current leakage from an electrical short defect can prevent an optical device from tinting locally which may appear as a bright area in an image taken of an optical device lite in a darkened tint state. The bright area is typically surrounded by a darker portion (sometimes referred to as a “halo”). In one aspect, the method locates the source or sources of one or more defects in the optical device by analyzing the bright areas in an image (e.g., image of local region or image of viewable area) taken of a lite while the optical device is in a darkened tint state. The method may, for example, identify a center and a boundary of each of one or more defect areas in the optical device by analyzing an image (e.g., image of local region or image of viewable area) taken of the lite while the optical device is in a darkened tint state. For example, a defect area may be determined by identifying neighboring pixels in an image that have intensities above a threshold intensity.

One technique for identifying spatial coordinates of a source of a defect determines a pixel in the image or the background image with a peak (highest) or nearly peak intensity. A nearly peak intensity can refer to an intensity within a certain percentage (e.g., 2%, 3%, 4%, or 5%) of a maximum pixel intensity in the image. Alternatively, the spatial coordinates of the source of a defect or sources of defects may be determined by visually inspecting the image for bright areas and manually marks a defect region center on the image. The co-ordinates may be defined in any type of spatial coordinate system (e.g., cartesian, polar, etc.). The laser controller can use or transform these co-ordinates during mitigation.

In certain aspects, a defect area is identified by determining a grouping of neighboring image pixels (pixels adjacent each other) having intensities within a particular intensity range. In these cases, the spatial coordinates of the defect area may be a geometric center of the grouping of neighboring image pixels or the location of a pixel with the highest intensity in the grouping. For example, a defect area may be identified as a grouping of neighboring pixels having intensities within a range of the maximum intensity in the image or other maximum intensity value, e.g., neighboring pixels having intensities within 2% of the maximum intensity value.

To help identify defect areas in an image from other objects in the image, a background image may be generated from the defect image (image taken from the camera or other imaging device) to remove objects in the image and/or to smooth the image, e.g., by filtering and cleaning image processing techniques. For example, the image may be convolved with a low-pass filter (e.g., normalized box filter, Gaussian filter, median filter, or bilateral filter, or matched filter) to remove all image objects from the image. In one aspect, the spatial coordinates of one or more defect areas in a region of interest may be determined using a background image or other enhanced image.

The background image can be created using different approaches. In one implementation, a combination of simple thresholding and sharpening is used to locate all objects with sharp edges and intensity different than the background. These objects are then removed to get a ‘smooth’ the background image without noise from objects (defect and non-defect objects). In another implementation, a first image is captured and de-focused to get a blurry image. This will be considered the background to the image. Next, a second in-focus image is captured of the same location and is further processed to combined with the first image to generate the background image. In a third implementation, a rolling ball algorithm is used to calculate and subtract the background image. In a fourth implementation, the image is re-sampled at a lower resolution to get a background image.

In certain methods of determining a polygon laser ablation pattern, the polygon ablation pattern includes data establishing one or more polygon boundaries that enclose all detectable defect areas (i.e. all defect areas distinguishable by imaging processing techniques discussed herein) to be repaired within a region of interest. The region of interest (ROI) may be defined as a region in the image around the spatial coordinates of one of the defect areas in the image. For example, the region of interest may be defined as a circular region centered around a defect area center. In one aspect, the radius of the circular region is a preset value or an operator-defined value that is not determined from image data. For example, the radius may be assigned a fixed value such as 1 μm, 2 μm, 3 μm, etc. In another aspect, the radius is determined by analyzing the image data. For example, the radius may be calculated by evaluating intensities of pixels at different locations in the image or by evaluating intensity gradients of pixels around the defect area center. In one case, the radius is defined as the distance between the defect area center and an outermost pixel in a single defect area. In another case, the radius is defined as the distance between the defect area center and an outermost pixel in a cluster of defect areas in order to generate a polygon boundary that encloses all defect areas in the cluster.

In certain aspects of the polygon ablation pattern method, defect areas within the region of interest are identified and boundaries around individual image objects (also referred to as “defect areas” in an image) are determined. Defect areas in an image may be identified using image processing techniques such as one or more of image filtering, background subtraction, image segmentation, thresholding, and morphological operations. If there are multiple defect areas in the region of interest, the method may determine whether any of these defect areas can be grouped in a cluster of defect areas. For example, defect areas determined to be within a certain distance of one another may be considered as forming a cluster of defect areas. In this case, the boundaries of individual defect areas in the cluster are combined to define a combined boundary that encloses the entire region around the defect areas in the cluster. Alternatively, the defect areas may be identified by visually inspecting the image for objects in image and manually marking the centers of objects.

In certain aspects, the spatial coordinates of the boundary pixels along the border of each individual defect area in the region of interest are determined. For example, image data (original or enhanced image such as a background image or processed image such as a filtered or background subtracted image) may be analyzed to determine areas of high intensity gradients to identify image pixels at the borders of defect areas. In some cases, the image used in this determination is enhanced to increase intensity gradients at the boundaries of the defect areas to better distinguish boundary pixels from the surrounding pixels. For example, the image may be enhanced using thresholding or filtering to assign pixels above a threshold intensity value to a first intensity (e.g., maximum intensity value in the image) and assign other pixels in the image to a second intensity (e.g., minimum intensity value such as to enhance the intensity contrast (increase intensity gradients) at the boundaries of the defect regions in the region of interest to the surrounding pixels. In this case, the boundary of a defect area may be defined by the spatial coordinates of the outermost pixels of the region of the image with pixels having the first intensity. Another method for determining the boundaries of a defect area is to first sharpen the image using one or more filters such as a log filter (Laplacian or gaussian filter) and then apply thresholding. Alternatively, one or more edge filters, such as a sobel filter and/or a canny filter, can be used to locate the edges of individual defect areas.

In certain aspects, a combined boundary is computationally generated around a cluster of defect areas in the region of interest. In some cases, image processing techniques may be used to determine if there is a cluster of defects in the image and to combine the boundaries. For example, dilation and/or erosion may be used to determine the relative distances between defect areas in the region of interest to determine if there is a cluster of defect areas and to also determine the order of combining the boundaries of the defect areas in the cluster. Dilation adds pixels to the boundaries of objects in an image, while erosion removes pixels on object boundaries. For example, dilation may be used to determine the distance between defect areas, e.g., based on when and where the expanding boundaries of the defect areas meet neighboring defect areas during dilation. The distance between neighboring defect areas may be used to determine the sequence for combining the boundaries of defect areas, e.g., in order of closest neighboring defect area to furthest neighboring defect area. In addition or alternatively, the distance between neighboring defects may be used to determine which defects areas to exclude from or include in the cluster of defect areas within a connected boundary. For example, defect areas within a certain distance of each other may be in one cluster. As another example, a cluster may be determined by counting the number of objects found in the ROI. Dilation and erosion functions (or a combination of them like closing and opening functions) can be used to combine boundaries of neighboring regions within pre-determined proximity.

In one aspect, morphological operations are used to connect the boundaries of a cluster of defect areas to combine into a connected boundary. In another aspect, dilation followed by erosion (also referred to as “closing”) can be used to combine neighboring regions into one. Additionally, skeletonizing a binary image and combining that with the original will result in a combined region while minimizing area affected.

In one aspect, the spatial coordinates of the pixels at the boundary of a defect area or the pixels at the connected boundary around a cluster of defect areas may be used to define a map of co-ordinates (polygon boundary) in the polygon ablation pattern. The co-ordinates define the path of the laser spot of a polygon boundary and/or scan across the region enclosed within the polygon boundary to repair the one or more defects in the optical device.

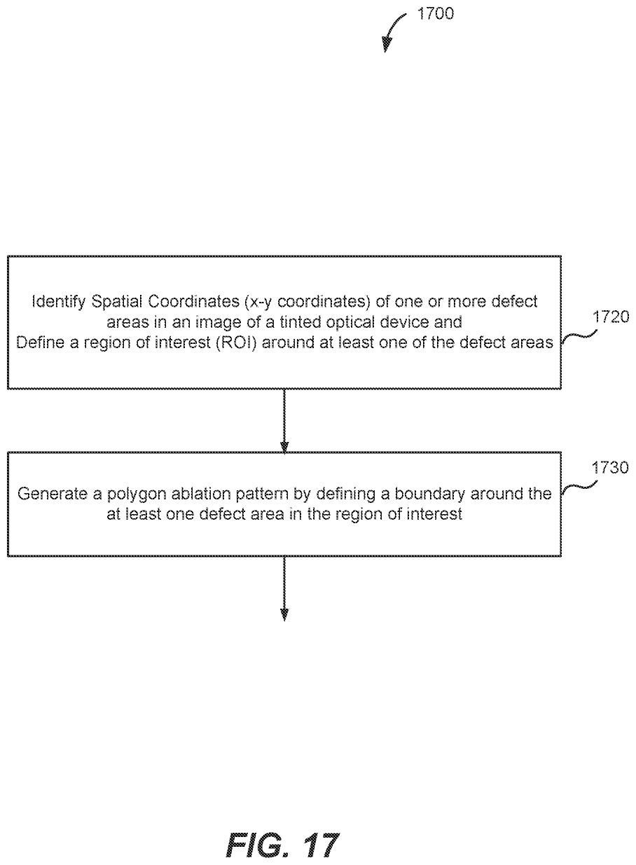

FIG. 17 is a flowchart illustrating operations of a method of determining a polygon ablation pattern employing imaging processing techniques, according to embodiments. At operation 1720, the spatial coordinates of one or more defect areas in an image are identified and a region of interest (ROI) is defined around at least one of the defect areas. At operation 1730, a polygon ablation pattern is defined with a polygon boundary around a defect area or a cluster of defect areas in the region of interest.

In one aspect, the method also includes one or more laser ablation operations that implement the polygon ablation pattern defined in operation 1730 to mitigate the one or more defects in the optical device. The laser ablation operations need not penetrate all the layers of the optical device stack (e.g., electrochromic device stack of layers 104, 106, 108, 110, and 114 shown in FIG. 1A). The laser ablation can penetrate any depth from removing the uppermost layer (e.g., layer 114 in FIG. 1A) to the full stack, and any depth between. In one example, laser ablation need only penetrate one of the transparent conductor layers of an optical device stack (e.g., transparent conductor 104 or 114 in FIG. 1A) in order to electrically isolate the stack material within the perimeter of the laser scribe line. The laser ablation may penetrate one, two, three, four, . . . or all layers of an optical device. In devices that have graded compositions rather than distinct layers, e.g., the electrochromic device described in association with FIG. 2, penetration of the entire device stack may be implemented.

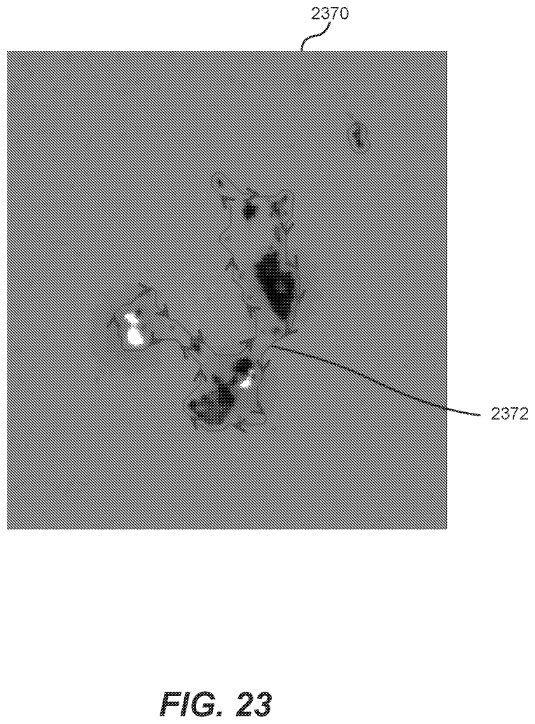

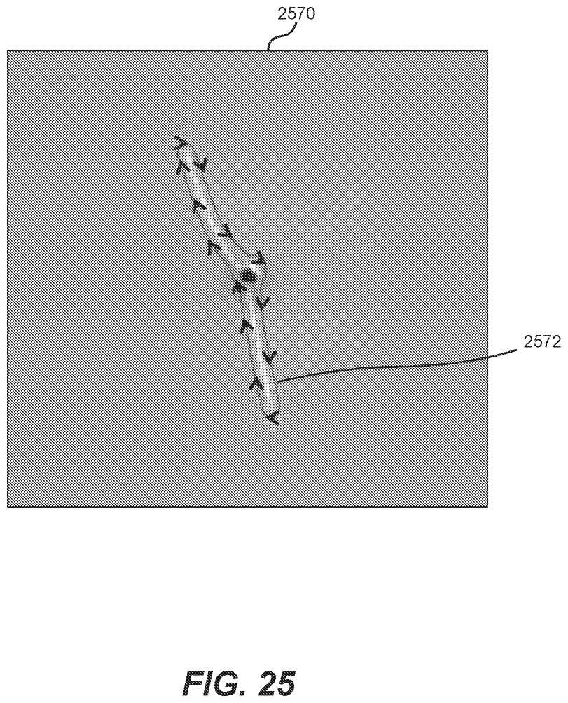

In certain implementations, the one or more laser ablation operations include a scribing process that causes one or more laser spots to follow a path along at least a portion of a polygon boundary of the polygon ablation pattern to enclose the one or more defect areas. An example of a laser path that follows along a polygon boundary 2372 of a polygon ablation pattern to surround a cluster of defects 2212 is shown in FIG. 23. An example of a laser path that follows along a polygon boundary 2572 of a polygon ablation pattern to enclose an elongated defect 2412 is shown in FIG. 25. Although the laser paths in these examples are shown to follow in the clockwise direction, the laser path may be followed in the opposite direction along at least a portion of the polygon boundary in other implementations. In some cases, the laser starts and/or stops scribing within the polygon boundary.

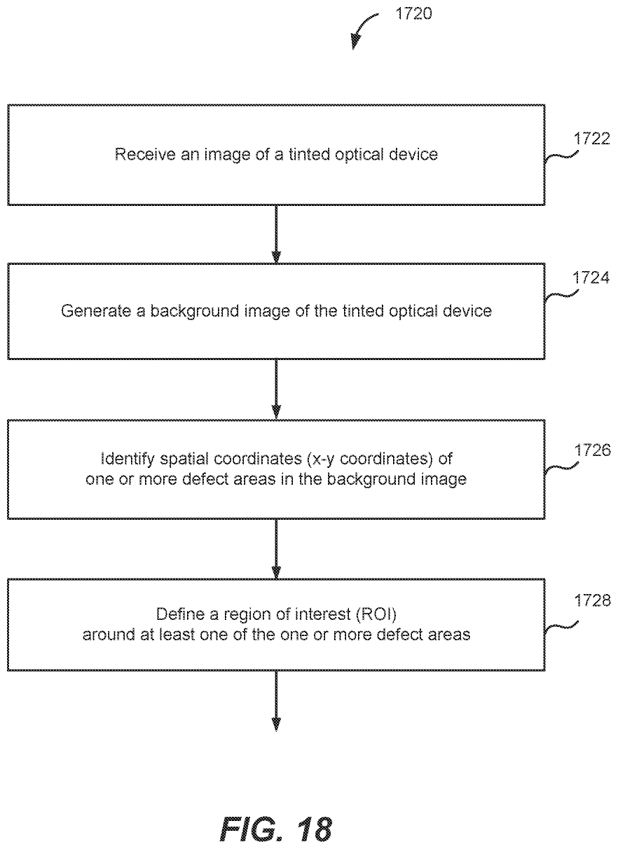

FIG. 18 is a flowchart illustrating an example of sub-operations of operation 1720 shown in FIG. 17, according to certain aspects. At operation 1722, a first image of the optical device lite while the optical device is in a darkened tint state is received. A microscopic camera or other imaging device may take the image while the optical device is held in the darkened tint state (by applying current/voltage). In one aspect, the image is of a viewable area of the optical device lite. The image is typically taken in transmission mode by detecting (e.g., by one or more image sensors) intensity of light passing through the optical device lite in a darkened tint state. In some cases, the image is captured by an imaging device located to one side of the lite while back light illumination is provided incident on the lite from the opposite side. The image is received, e.g., at a computing device that performs image processing operations and that is in electrical communication with the imaging device. In one case, the imaging device is mounted to an x-y stage to image different regions across a viewable area of the lite.

In one aspect, the imaging device takes a first image of the entire viewable area of the optical device lite, and after a local region of the lite with one or more defects being mitigated is located, the imaging device takes a second image that is focused on the local region.

Returning to FIG. 18, at operation 1724, a background image of the optical device is generated by removing one or more objects from the first image and/or smoothing the first image, e.g., by filtering and cleaning image processing techniques. For example, the first image may be convolved with a low-pass filter (e.g., a normalized box filter, a Gaussian filter, a median filter, or a bilateral filter) to remove one or more objects and other noise from the image to generate the background image. In some cases, all objects may be removed.

At operation 1726, the spatial coordinates of the one or more defect areas in the background image are determined. For example, the spatial coordinates of a source of a defect may be determined by identifying a pixel or group of pixels in the background image having a peak (highest) or nearly peak intensity. A peak (highest) intensity can refer to a maximum pixel intensity value in the image or another maximum value. A near peak intensity can refer to any pixel intensity value that is within a certain percentage % (e.g., 2%, 3%, 4%, or 5%) of the maximum intensity value. If multiple neighboring pixels have the peak or near peak intensities, the spatial coordinates of the geometric center of the multiple neighboring pixels may be used.

In another embodiment, operation 1726 includes sub-operations 1722, 1726 and 1728 (omitting sub-operation 1724) and sub-operations 1726 and 1728 are performed by analyzing data from the first image of the tinted optical device received in sub-operation 1722.

In certain methods of determining a polygon laser ablation pattern, the polygon ablation pattern includes data establishing one or more polygon boundaries that enclose all detectable defect areas (i.e. all defect areas distinguishable by imaging processing techniques discussed herein) within a region of interest.

Returning to FIG. 18, a region of interest (ROI) is defined around one or more defects areas in the original image received from the imaging device (operation 1728). According to one aspect, the polygon ablation pattern will include data establishing one or more polygon boundaries that enclose all detectable defect areas (i.e. all defect areas distinguishable by imaging processing techniques discussed herein) within the defined region of interest. The region of interest (ROI) is defined as a region in the first image centered around the spatial coordinates of one of the defect areas identified in operation 1726. the ROI may be defined, for example, as a circular region or other region (e.g., polygonal) centered around a defect area center. In one aspect, the radius of the circular region is a value (e.g., 1 μm, 2 μm, or 3 μm) that does not depend on the image. In another aspect, the radius is determined by analyzing the image data. For example, the radius may be calculated by evaluating intensities of pixels at incrementally increasing distances away from the defect area center until the intensity drops below a lower threshold value to define a radius that defines a circular region that will include a cluster of defect areas or an elongated defect area. In one instance, the radius is defined as a distance between the defect area center and an outermost pixel in a cluster of neighboring defect areas in the first image.

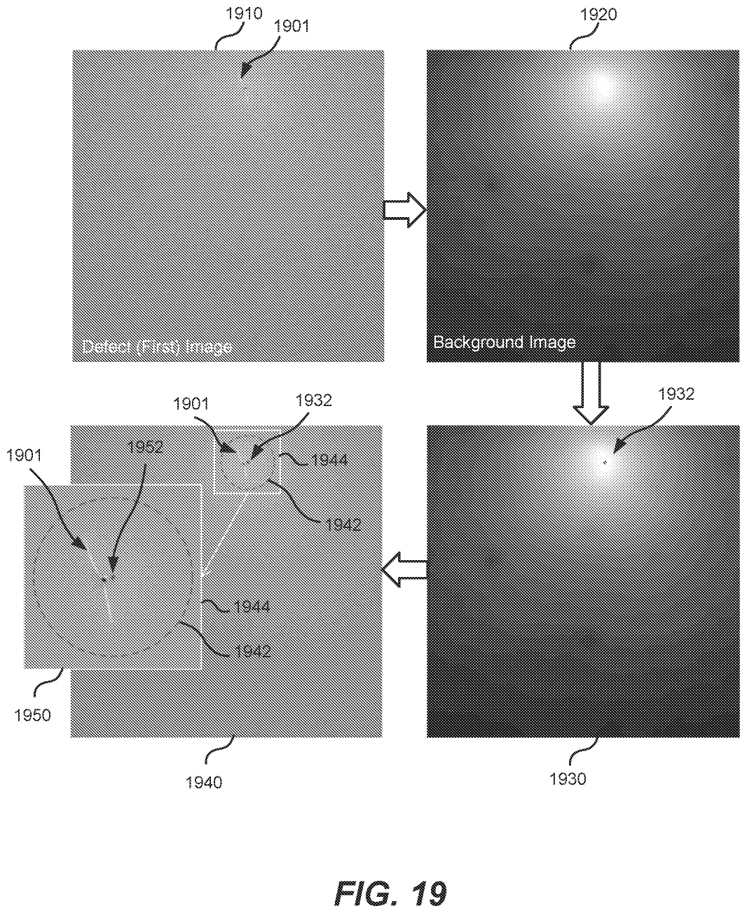

FIG. 19 includes an arrangement of images of a tinted electrochromic device that schematically illustrates output from and the flow of image processing sub-operations 1722, 1724, 1726, and 1728 shown in FIG. 18, according to one aspect. The illustrated arrangement includes a first defect image 1910 (top leftmost image) that is an example of an image taken by an imaging device (e.g., microscopic camera) of the viewable area of an electrochromic device lite with the electrochromic device held in a darkened tint state and received at an exemplary sub-operation 1722 (shown in FIG. 18). The image is captured in transmission mode with backlighting illumination. The first defect image 1910 shows an elongated defect 1901 in the electrochromic device. The illustrated arrangement also includes a first background image 1920 generated from the first defect image 1910, which is an illustrated example of output from sub-operation 1724 (shown in FIG. 18). The illustrated arrangement also includes a second background image 1930 that includes an asterisk identifying the spatial coordinates of a defect area at a defect region center 1932, which is an illustrated example of output from sub-operation 1726 (shown in FIG. 18). In this example, the defect region center 1932 is identified by locating the pixel with a peak intensity value in the second background image 1930. The spatial coordinates of the defect region center 1932 map directly to a location on the electrochromic lite. The illustrated arrangement also includes a second defect image 1940 with a circular region of interest 1942 defined around the spatial coordinates of the defect region center 1932, corresponding to an exemplary sub-operation 1728 (shown in FIG. 18). The radius of the region of interest 1942 is defined to be large enough to enclose the elongated defect 1901. A rectangular portion 1944 of the second defect image 1940 with the circular region of interest 1942 is shown in an expanded image 1950.

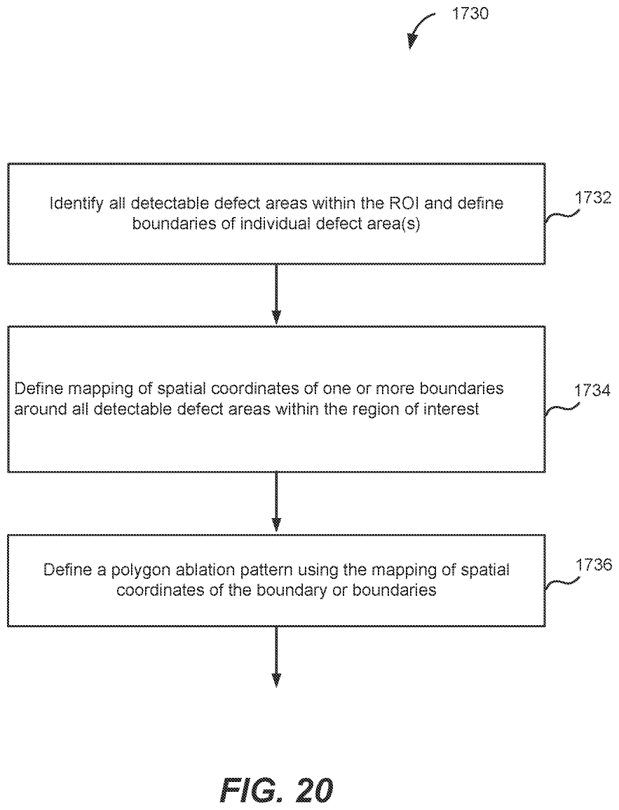

FIG. 20 is a flowchart illustrating an example of sub-operations 1732, 1734, and 1736 of the operation 1730 shown in FIG. 17, according to certain aspects. At operation 1732, all detectable defect areas (i.e. all defect areas distinguishable by imaging processing techniques discussed herein) are identified in the region of interest and the boundaries of the defect area(s) (image objects) are defined. The defect areas may be identified using image processing techniques such as one or more of image filtering, thresholding, and morphological operations.

At operation 1732, either the an image from the imaging device or an enhanced image (e.g., a background image) of one or more of the images from the imaging device is analyzed to identify all detectable defect areas in the region of interest to be repaired. The method may identify, for example, a defect area in an image by determining a grouping of neighboring image pixels (pixels adjacent each other) having peak or nearly peak intensity values. For example, a defect area may be identified as a grouping of neighboring pixels having intensities within a range of a maximum intensity value of all pixel intensity values in the image. In addition or alternatively, the method may identify a defect area in the region of interest by defining a boundary around the defect area. A boundary around a defect area may be determined by identifying boundary pixels at regions of high intensity gradient in the image. In some cases, the image is enhanced to increase intensity gradients at the boundaries to help distinguish boundary pixels from pixels surrounding the defect areas. For example, the image may be enhanced using thresholding or filtering to assign pixels above a threshold intensity value to a first intensity (e.g., maximum intensity) and assign other pixels in the image to a second intensity (e.g., minimum intensity value such as 0) to enhance the intensity contrast (increase intensity gradients) at the boundaries of the defect regions. In this example, the boundary of a defect area is defined by the spatial coordinates of the outermost boundary pixels in the region of the image with neighboring pixels having the first intensity.

At operation 1734, a mapping of spatial coordinates of one or more boundaries defined around all detectable defect areas in the region of interest. If there is a single detectable defect area in the region of interest, the mapping of spatial coordinates is one boundary around the one detectable defect area. If there is a cluster of defect areas in the region of interest, a combined boundary is defined around the cluster of defect areas based on the boundaries of the individual defect areas in the cluster. In some cases, morphological operations may be used to “connect” the boundaries of the defect areas in the cluster to combine the boundaries into a single connected region. Dilation and/or erosion techniques may be used, e.g., to determine the relative distances between defect areas in the region of interest to determine if there is a cluster of defect areas in the region of interest and/or the order of combining the boundaries of the defect areas in the cluster. For example, dilation may be used to incrementally add pixels to the boundaries of the defect areas to determine the relative distance between neighboring defect areas in the region of interest. The relative distance between neighboring defects may be used to determine which defect areas are in a cluster. For example, all defect areas within a certain distance from a neighboring defect area may be determined to be part of a single cluster. The distance between neighboring defect areas in a cluster may be used to determine the sequence for combining the boundaries of the defect areas. For example, the two closest defect areas may be combined first. The boundaries of defect areas in the cluster are combined to define a combined boundary that encloses the entire region around the defect areas in the cluster. The spatial coordinates of the pixels at the boundary of a single defect area or of the pixels at the connected boundary around a cluster of defect areas may be mapped to co-ordinates on the lite defining a polygon boundary in the polygon ablation pattern.

At operation 1736, the polygon ablation pattern for mitigating one or more defects in the optical device lite is defined based on the mapping of the spatial coordinates of the one or more boundaries. In one aspect, the mapping of co-ordinates is used to define a path of a laser spot along a polygon boundary around the one or more defects in the optical device lite. In addition or alternatively, the mapping of co-ordinates may be used to define a scanning (e.g., raster scanning) of a laser spot across a region enclosed within the polygon boundary.

In certain aspects, the polygon boundary used in the polygon ablation pattern may be defined by enlarging a boundary around one or more defect areas. In one aspect, the polygon boundary may be defined at spatial coordinates that are at a distance, e.g., 5 μm, 10 μm, etc., outward from the boundary. In another aspect, the polygon boundary may be defined at spatial coordinates that are based on dilating the boundary by a certain percentage 5%, 10%. For example, dilation may be used to add one or more pixels outward from the border of a combined region of a cluster of defects and the dilated region used to determine the polygon boundary for the ablation pattern.

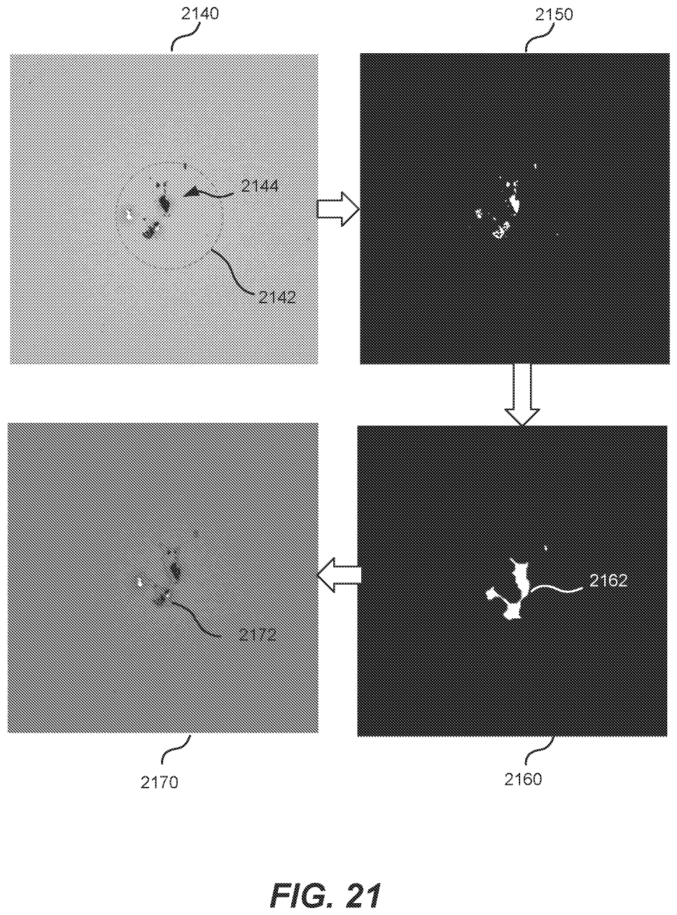

FIG. 21 includes an arrangement of images of a tinted electrochromic device that schematically illustrates output from and the flow of image processing sub-operation 1728 shown in FIG. 18 and image processing sub-operations 1732, 1734, and 1736 shown in FIG. 20, according to one aspect. The illustration includes a first (defect) image 2140 that is an example of an image taken of the electrochromic device in a darkened tint state in transmission mode with backlighting. The first defect image 2140 includes a cluster of defect areas 2144 and a region of interest 2142 defined around the cluster of defect areas 2144 with a radius defined to enclose all the defect areas in the cluster, which is an illustrated example of output from sub-operation 1728 shown in FIG. 18. The illustrated arrangement also includes a first enhanced image 2150 generated from the first (defect) image 2140 to enhance the intensity gradients at the boundaries of the defect areas to determine the defect areas within the region of interest 2142, which is an example of an operation that may be done at sub-operation 1732 shown in FIG. 20. For example, the first enhanced image 2150 may have been generated using thresholding or filtering to assign pixels above a threshold intensity value to a first intensity (e.g., maximum intensity) and assign other pixels in the image to a second intensity (e.g., minimum intensity value such as 0) to enhance the intensity contrast (increase intensity gradients) at the boundaries of the defect regions. The illustrated arrangement in FIG. 21 also includes a second enhanced image 2160 with a combined boundary 2162 that was generated by connecting the boundaries of defect areas in the cluster 2144 to neighboring boundaries to enclose the entire region around the defect areas in the cluster, which is an example of a procedure that may be done at sub-operation 1734 shown in FIG. 20. The illustration also includes a second defect image 2170 with a polygon boundary 2172 defined by the mapping of spatial coordinates of the combined boundary 2162 around the cluster of defects 2144, which is an example of a procedure that may be done at sub-operation 1736 shown in FIG. 20. The mapping of the co-ordinates defines a path of a laser spot along the polygon boundary 2172 around the cluster of defects 2144 in the polygon ablation pattern.

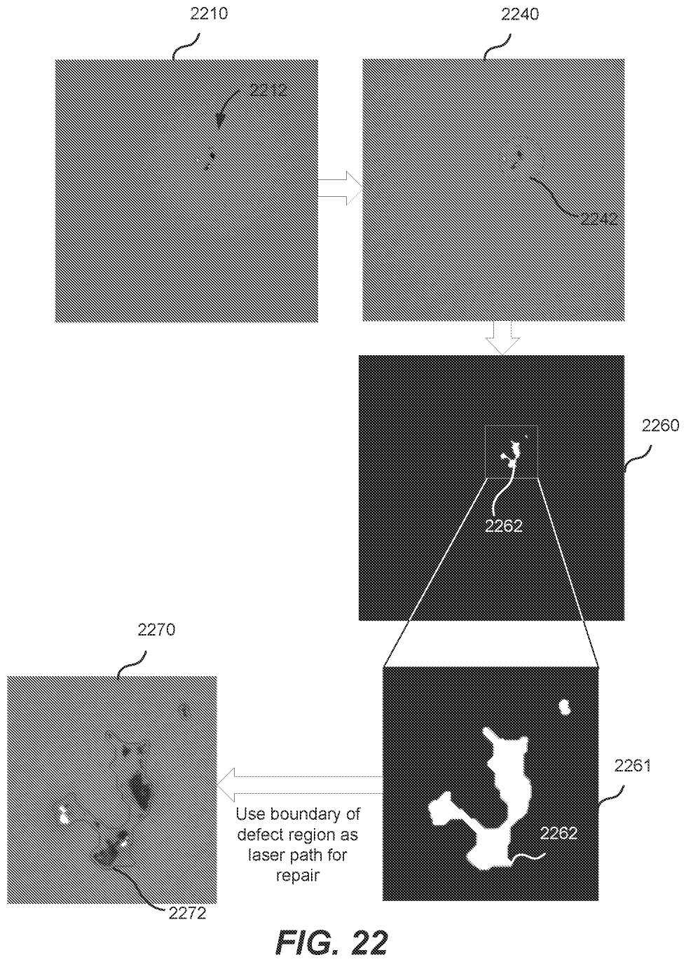

FIG. 22 includes an arrangement of images of a tinted electrochromic device that schematically illustrates output from and the flow of image processing sub-operations 1722 and 1728 shown in FIG. 18 and image processing sub-operations 1734, and 1736 shown in FIG. 20, according to one aspect. The illustrated arrangement includes a first defect image 2210 (top leftmost image) that is an example of an image taken by an imaging device (e.g., microscopic camera) of the viewable area of an electrochromic device lite with the electrochromic device held in a darkened tint state and received at an exemplary sub-operation 1722 shown in FIG. 18. The first defect image 2210 is captured in transmission mode with backlighting illumination. The first defect image 2210 shows a cluster of defect areas 2212 in the electrochromic device. The illustrated arrangement also includes a second defect image 2240 with a circular region of interest 2242 defined to enclose the cluster of defect areas 2212, corresponding to an example of sub-operation 1728 shown in FIG. 18. The illustrated arrangement also includes a first enhanced image 2260 with a circular region of interest 2242 defined to enclose the cluster of defect areas 2212, corresponding to an example of sub-operation 1728 shown in FIG. 18. The illustrated arrangement in FIG. 22 also includes a first enhanced image 2260 with a combined boundary 2262 that was generated by connecting the boundaries of defect areas in the cluster 2212 to neighboring boundaries to enclose the entire region around the defect areas in the cluster, which is an example of a procedure that may be done at sub-operation 1734 shown in FIG. 20. A rectangular portion of the first enhanced image 2260 is shown in an expanded portion 2261. The illustration also includes a third non-enhanced image 2270 of the rectangular portion with a polygon boundary 2272 defined by the mapping of spatial coordinates of the combined boundary 2262 around the cluster of defects 2212, which is an example of output from a procedure that may be done at sub-operation 1736 shown in FIG. 20.

FIG. 23 includes an expanded image 2370 of the rectangular portion of the non-enhanced defect image of the lite shown in FIG. 22. The mapping of the co-ordinates at the combined boundary 2262 around the cluster of defects 2212 is used to define a path of a laser spot along a polygon boundary 2372 around the cluster of defects 2212 in the polygon ablation pattern. The laser path will be provided as a series of spatial coordinates that follow (according to illustrated arrows) the polygon boundary 2372 based on the combined boundary 2262 around the cluster of defects 2212. The laser can follow this path to create an enclosed repair polygon ablation pattern. The defined path may represent the center of the scribe line.

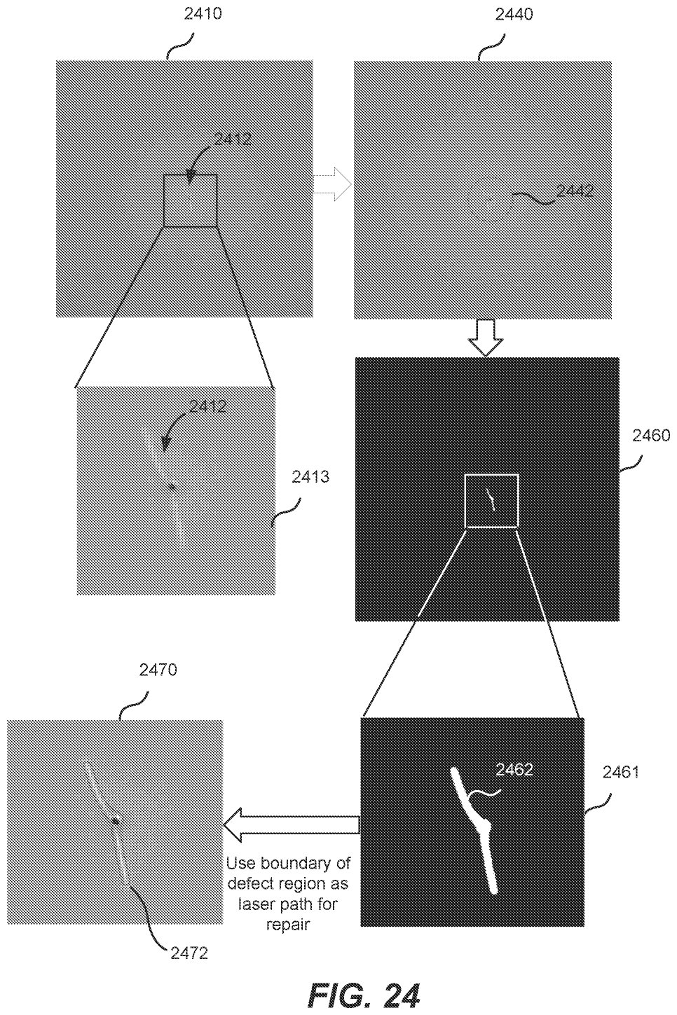

FIG. 24 includes an arrangement of images of a tinted electrochromic device that schematically illustrates output from and the flow of image processing sub-operations 1722 and 1728 shown in FIG. 18 and image processing sub-operations 1734, and 1736 shown in FIG. 20, according to one aspect. The illustrated arrangement includes a first defect image 2410 (top leftmost image) that is an example of an image taken by an imaging device (e.g., microscopic camera) of the viewable area of an electrochromic device lite with the electrochromic device held in a darkened tint state and received at an exemplary sub-operation 1722 shown in FIG. 18. The first defect image 2410 is captured in transmission mode with backlighting illumination. The first defect image 2410 shows an elongated defect 2412 in the electrochromic device. A rectangular portion of the first defect image 2410 with the elongated defect 2412 is shown in an expanded portion 2413. The illustrated arrangement also includes a second defect image 2440 with a circular region of interest 2442 defined to enclose the elongated defect 2412, corresponding to an example of sub-operation 1728 shown in FIG. 18. The illustrated arrangement also includes a first enhanced image 2460 with a circular region of interest 2442 defined to enclose the elongated defect 2412, corresponding to an example of sub-operation 1728 shown in FIG. 18. The illustrated arrangement in FIG. 22 also includes a first enhanced image 2460 with a boundary 2462 that was generated at the boundary of the elongated defect 2412, which is an example of a procedure that may be done at sub-operation 1734 shown in FIG. 20. A rectangular portion of the first enhanced image 2460 is shown in an expanded portion 2461. The illustration also includes a third non-enhanced image 2470 of the rectangular portion with a polygon boundary 2472 defined by the mapping of spatial coordinates of the boundary 2262 around the elongated defect 2412, which is an example of output from a procedure that may be done at sub-operation 1736 shown in FIG. 20.

FIG. 25 includes an expanded image 2570 of the rectangular portion of the non-enhanced defect image of the lite shown in FIG. 24. The mapping of the co-ordinates of the boundary 2462 around the elongated defect 2412 is used to define a path of a laser spot along a polygon boundary 2572 around the elongated defect 2412 in the polygon ablation pattern. The laser path will be provided as a series of spatial coordinates that follow (according to illustrated arrows) the polygon boundary 2572 according to the boundary of the elongated defect 2412. The laser can follow this path to create an enclosed repair polygon ablation pattern. The defined path may represent the center of the scribe line.

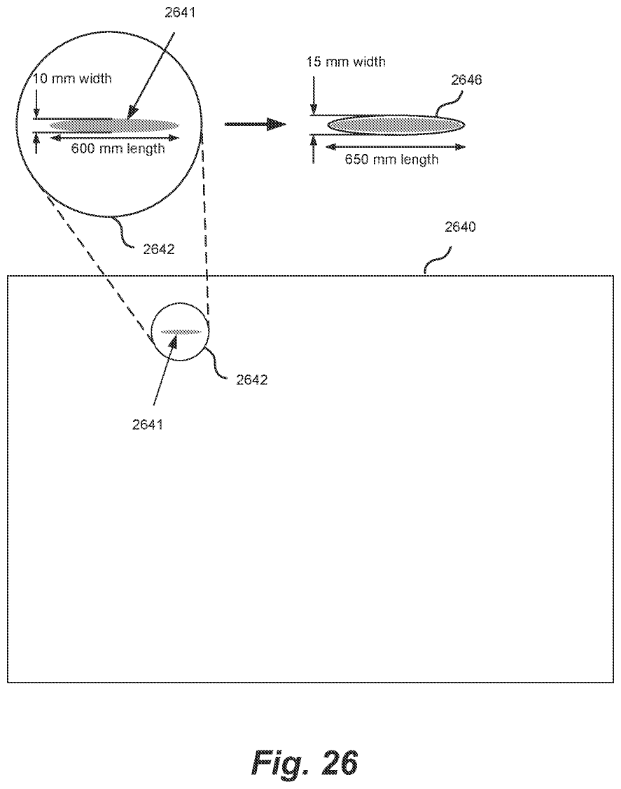

FIG. 26 is a schematic illustration of a method of mitigating an elongated defect in an electrochromic lite that includes a technique for generating a polygon ablation pattern, according to one aspect. The method of mitigating includes: 1) detecting the elongated defect in an image of the electrochromic lite; and 2) mitigating the elongated defect using a polygon ablation pattern. FIG. 26 illustrates an image 2640 of an electrochromic device having an elongated defect 2641 and a region of interest 2642 defined around the geometric center of an elongated defect 2641. FIG. 26 also illustrates an expanded view of the region of interest 2642 showing exemplary dimensions of the elongated defect 2641 are 10 μm in width and 600 μm in length. A method of determining a polygon ablation pattern, as described herein, is used to define a polygon 2646 adapted to the shape of the elongated defect 2641 with a 15 μm in width and 650 μm in length, which is larger than the size of the elongated defect 2641. In this case, the polygon 2646 is defined at spatial coordinates that are outward (2.5 μm added to upper and lower sides in width and 25 μm added to right and left sides in length) from the boundary of the elongated defect 2641. The polygon boundary of the polygon ablation pattern includes any number of segments that may be suitable to surround the shape of the defect(s) such as the oval shape of the elongated defect 2641 shown in FIG. 26.

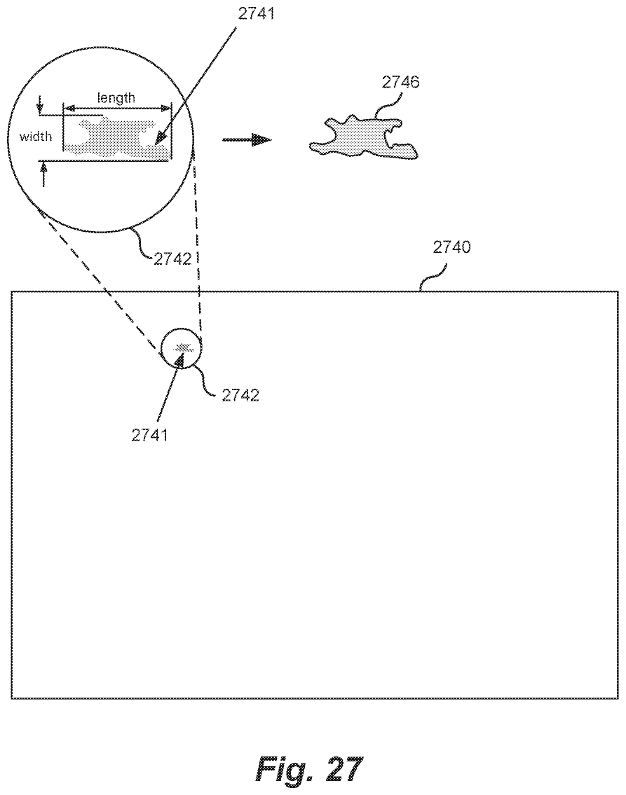

FIG. 27 is a schematic illustration of a method of mitigating a defect in an electrochromic lite that includes a technique for generating a polygon ablation pattern, according to one aspect. The method of mitigating includes: 1) detecting the defect in an image of the electrochromic lite; and 2) mitigating the defect using a polygon ablation pattern. FIG. 27 illustrates an image 2740 of an electrochromic device having an defect 2741 and a region of interest 2742 defined around the geometric center of the defect 2741. FIG. 26 also illustrates an expanded view of the region of interest 2742 showing dimensions of the defect 2741 are width (e.g., 200 μm) and length (e.g., 600 μm). A method of determining a polygon ablation pattern, as described herein, is used to define a polygon 2746 adapted to the shape of the defect 2741 by following a boundary of the defect area. A method of determining a polygon ablation pattern, as described herein, is used to define a polygon 2746 adapted to the shape of the defect 2741 is 200 μm in width and 600 μm in length, which is the same as the width and length of the defect 2741.

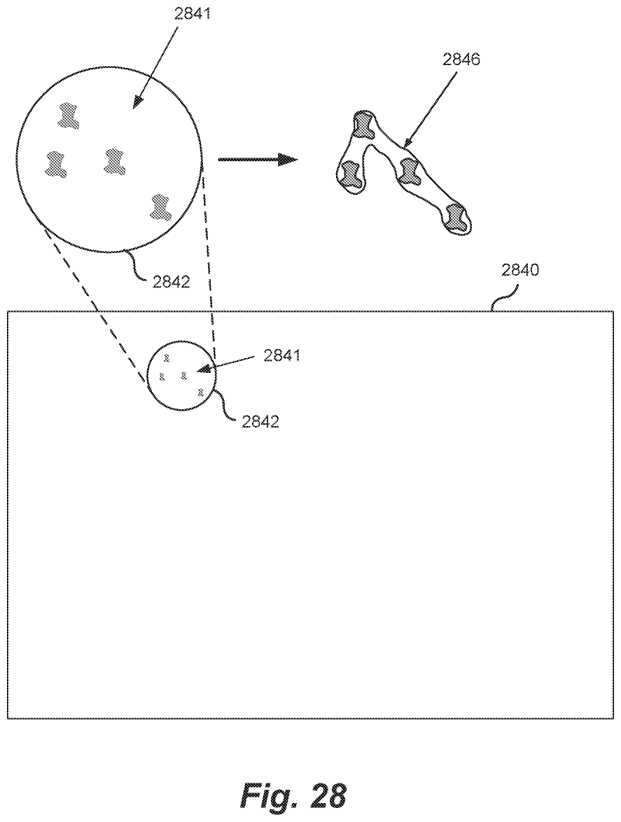

FIG. 28 is a schematic illustration of a method of mitigating a cluster of defects in an electrochromic lite that includes a technique for generating a polygon ablation pattern, according to one aspect. The method of mitigating includes: 1) detecting the cluster of defects in an image of the electrochromic lite; and 2) mitigating the cluster of defects using a polygon ablation pattern. FIG. 28 illustrates an image 2840 of an electrochromic device showing a cluster of defects 2841 from a debris field of small particles and a region of interest 2842 defined around the geometric center of the cluster of defects 2841. FIG. 28 also illustrates an expanded view of the region of interest 2842. A method of determining a polygon ablation pattern, as described herein, is used to define a polygon 2846 adapted to the shape of the debris field by connecting the boundaries of the individual defects to generate a combined boundary and enlarging the combined boundary. In this case, the polygon 2846 is defined at spatial coordinates that are outward from the combined boundary of cluster of defects 2841.

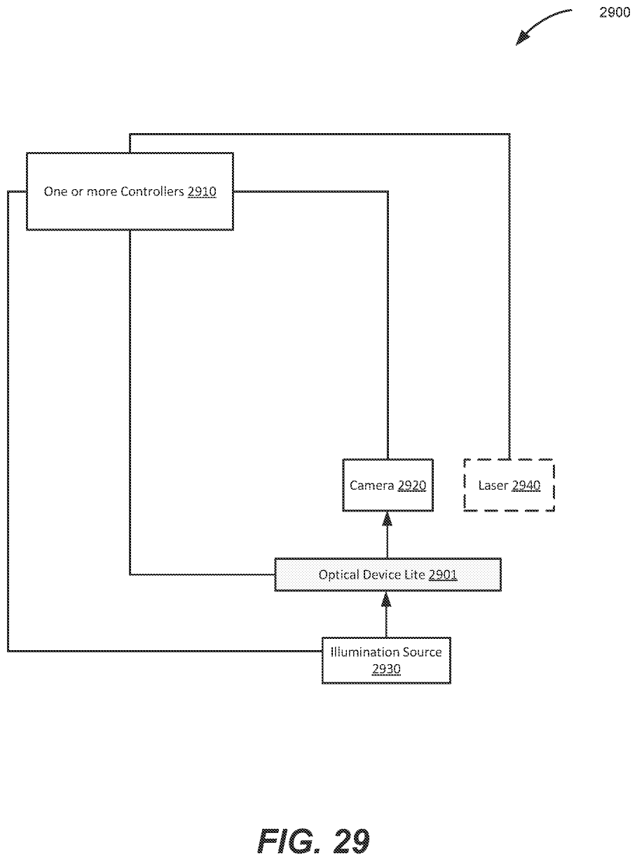

FIG. 29 is a schematic diagram of a system 2900 for generating a polygon ablation pattern based on one or more defects in an optical device, according to certain embodiments. The system 2900 is shown during operation while an optical device lite 2901 is being imaged in transmission mode. The system 2900 includes one or more controllers 2910, a camera 2920 in electrical communication with the one or more controllers 2910, an illumination source 2930 in electrical communication with the one or more controllers 2910, and optionally (denoted by dashed line) a laser 2940 in electrical communication with the one or more controllers 2910. The illumination source 2930 is configured to provide backside illumination to the optical device lite 2901 being imaged and the camera receives light transmitted through the optical device lite 2901 while the optical device is held in a darkened tint state by current/voltage applied to the optical device based on signals sent by the one or more controllers 2910. The camera takes at least one image of the optical device lite 2901 and communicates image data with the at least one image to the one or more controllers 2910. The one or more controllers 2910 use image processing techniques to generate a polygon ablation pattern with a polygon boundary around the one or more defects in the optical device. The one or more controllers 2910 may also direct the laser 2940 to cause a laser spot to follow the polygon boundary to mitigate the one or more defects.

Although the foregoing embodiments have been described in some detail to facilitate understanding, the described embodiments are to be considered illustrative and not limiting. It will be apparent to one of ordinary skill in the art that certain changes and modifications can be practiced without avoiding the scope of the following claims.

1. A method of determining a polygon ablation pattern for mitigating one or more defects in an optical device, the method comprising: a. identifying spatial coordinates of one or more defect areas in a first image of the optical device taken when tinted; b. defining a region of interest around at least one defect area of the one or more defect areas; and c. determining a polygon boundary around the at least one defect area in the region of interest to define the polygon ablation pattern.

2. The method of claim 1, further comprising generating a background image from the first image of the optical device.

3. The method of claim 2, wherein the background image is generated by removing one or more objects from the first image.

4. The method of claim 3, wherein the background image is generated using filtering and/or thresholding to remove the one or more objects from the first image.

5. The method of claim 2, wherein the at least one defect area comprises a group of neighboring pixels having peak intensities in the background image.

6. The method of claim 5, wherein peak intensities comprise intensity values within 1%, within 5%, or within 10% of a maximum pixel intensity value in the background image.

7. The method of claim 2, further comprising determining each of the at least one defect area by identifying a group of neighboring pixels in the region of interest having peak intensities in the background image.

8. The method of claim 7, wherein peak intensities are intensities within 1%, 5%, or 10% of a maximum pixel intensity in the first image.

9. The method of claim 1, wherein spatial coordinates of each of the one or more defect areas are at a geometric center of a group of neighboring pixels having peak intensities.

10. The method of claim 1, wherein spatial coordinates of each of the one or more defect areas are at a location of a pixel of the first image having an intensity within 5% of a maximum intensity.

11. The method of claim 1, further comprising receiving the first image of the optical device from a camera.

12. The method of claim 1, wherein the optical device is an electrochromic device.

13. The method of claim 2, wherein the region of interest is a circular region defined by a radius and centered around a defect region center of a group of neighboring pixels having peak intensities in the background image.

14. The method of claim 13, wherein the radius is in a range from about 10 μm to about 100 μm.

15. The method of claim 14, further comprising determining the radius using the background image.

16. The method of claim 14, further comprising determining the radius using spatial coordinates of an outermost pixel in a group of neighboring pixels having peak intensities in the background image.

17. The method of claim 2, wherein the at least one defect area in the region of interest comprises a cluster of defect areas; and wherein the polygon boundary is determined by combining boundaries of defect areas in the cluster of defect areas.

18. The method of claim 17, wherein the polygon boundary is determined by pixels identified at a border of a connected region formed by combining boundaries of defect areas in the cluster of defect areas.

19. The method of claim 17, wherein c. comprises identifying the cluster of defect areas in the region of interest of the background image as defect areas within a distance of each other.

20. The method of claim 19, wherein the distance is one of 1 μm, 2 μm, 3 μm, 4 μm, and 5 μm.

21. The method of claim 17, further comprising using a morphological operation to combine the boundaries of the defect areas in the cluster of defect areas.

22. The method of claim 17, wherein c. comprises: defining boundaries of all defect areas within the region of interest; and determining the polygon boundary by combining boundaries of defect areas in the cluster of defect areas.

23. The method of claim 17, wherein c. comprises determining the polygon boundary around each of the cluster of defect areas using one or more of an image filtering operation, an image thresholding operation, and a morphological operation.

24. The method of claim 1, further comprising:
(i) directing, or causing the direction of, one or more laser spots to follow the polygon boundary; and/or
(ii) directing, or causing the direction of, one or more laser spots to scan over a region within the polygon boundary.

25. The method of claim 1, further comprising directing, or causing the direction of, one or more laser spots to ablate along at least a portion of the polygon boundary.

26. The method of claim 25, wherein the one or more laser spots start and stop within the polygon boundary.

27. The method of claim 24, wherein the one or more laser spots follow a path that overlap along the polygon boundary.

28. The method of claim 27, wherein the one or more laser spots follow a path that overlaps by at least 10%.

29. The method of claim 27, wherein depth of laser ablation is at least through an uppermost layer of the optical device.

30. The method of claim 27, wherein depth of laser ablation is at least through one or more transparent conductor layers of the optical device.

31. The method of claim 27, wherein depth of laser ablation is through all layers of the optical device.

32. The method of claim 1, further comprising directing, or causing the direction of, one or more laser spots to scan over the entire region within the polygon boundary.

33. A method of mitigating one or more defects in an optical device, the method comprising:
identifying spatial coordinates of one or more defect areas in an image of the optical device taken when tinted;
determining a polygon boundary around the one or more defect areas; and
directing, or causing the direction of, one or more laser spots to follow along the polygon boundary to mitigate the one or more defects in the optical device.

34. The method of claim 33, wherein the one or more laser spots start and stop within the polygon boundary.

35. The method of claim 33, wherein the one or more laser spots follow a path that overlaps.

36. The method of claim 33, wherein the one or more laser spots follow a path that overlaps by at least 10%.

37. The method of claim 33, wherein depth of laser ablation is at least through an uppermost layer of the optical device.

38. The method of claim 33, wherein depth of laser ablation is at least through one layer of the optical device.

39. The method of claim 33, wherein depth of laser ablation is at least through one or more transparent conductor layers of the optical device.

40. The method of claim 33, wherein depth of laser ablation is through all layers of the optical device.
